(19) United States
(12) Patent Application Publication
(10) Pub. No.: US 2026/0300324 A1
(43) Pub. Date: Oct. 1, 2026

(54) SYSTEM AND/OR METHOD FOR ELECTRONIC PROCESSING OF SIGNALS STORED IN MEMORY FOR PRESENTATION OF HIERARCHICALLY SORTED CONTENT ON A DISPLAY DEVICE

(71) Applicant: HTS, LLC, Durango, CO (US)

(72) Inventor: Jeffery Lamonde Carter, Durango, CO (US)

(21) Appl. No.: 19/097,531

(22) Filed: Apr. 1, 2025

(51) Int. Cl. G06F 16/28; G06F 9/451

(52) U.S. Cl. CPC G06F 16/287; G06F 9/451

(57) ABSTRACT

Disclosed are a system, method and apparatus for electronically processing of signals stored in memory for presentation of hierarchically sorted content on a display device. In one aspect, responsive to user inputs received via a graphical user interface (GUI) integrated with the display device, a predefined hierarchical taxonomy may be applied to a node of a displayed hierarchical graph to append one or more child nodes to the node in a modified hierarchical graph.

### BACKGROUND

### 1. Field

This disclosure relates to methods and/or techniques for electronically processing of signals stored in memory for presentation of hierarchically sorted content on a display device.

### 2. Information

Techniques for analysis of electronically maintained data objects obtained from search and retrieval providers typically includes an end user downloading and formatting retrieved information into a spreadsheet. Application of analytical tools using a manual process may take significant man hours for manipulation of the formatted information to yield meaningful results. One technique to improve efficiency in analysis of data objects in large corpuses of data objects have included reuse of queries that are maintained in a library of queries.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIGS. 1A through 1R are diagrams of depictions of selections made in a graphical user interface (GUI) for affecting processing of data objects electronically stored in memory for presentation of images on a display device integrated with the GUI, according to an embodiment;

FIGS. 2A and 2B are flow diagrams of processes to electronically process hierarchically sorted content stored in a memory, according to embodiments;

FIGS. 3A and 3B is a schematic diagram of implementations of a generative neural network model for generating terms to determine classification attributes to define a node in a hierarchical graph, according to an embodiment; and

FIG. 4 is a schematic block diagram of an example computing system in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents. Further, it is to be understood that other embodiments may be utilized. Also, embodiments have been provided of claimed subject matter and it is noted that, as such, those illustrative embodiments are inventive and/or unconventional; however, claimed subject matter is not limited to embodiments provided primarily for illustrative purposes. Thus, while advantages have been described in connection with illustrative embodiments, claimed subject matter is inventive and/or unconventional for additional reasons not expressly mentioned in connection with those embodiments. In addition, references throughout this specification to “claimed subject matter” refer to subject matter intended to be covered by one or more claims, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

Search results formatted in a flat electronic spreadsheet may be organized by columns, rows and tabs. While spreadsheet formats may be effective for processing, updating and/or retrieving items maintained by row, column and/or tab, spreadsheet formats may be less effective at visually presenting an ontology, taxonomy and/or hierarchical structure.

According to an embodiment, to assist in storage and/or retrieval of items stored in a physical memory, a computerized system may express features relating to such stored items in a graph including nodes representing data objects and edges connecting such nodes to represent relationships between and/or among such data objects. In this context, the term “graph” as used herein is to mean one or more signals and/or memory states expressing such nodes and edges. In one aspect, features of a graph may be visually presented on a computer screen and/or display device such as a computer screen and/or display device integrated with a graphical user interface (GUI).

As discussed below in various embodiments, nodes in a hierarchical graph presented on a display device integrated with a GUI are electronically linked to data objects maintained in a memory associated with the nodes according to a hierarchical taxonomy. User interaction with the GUI to specify and/or modify classification attributes defining nodes in the hierarchical graph enhances efficiency and utility for the process of analyzing large collections of data objects. Additionally, abstraction of classification of a hierarchical graph/hierarchical taxonomy to a data structure enables convenient application of the data structure of a single hierarchical taxonomy to multiple different corpuses of data objects, making the single hierarchical taxonomy re-usable for multiple projects. These and other features described herein impart these and other practical applications in the processing and hierarchical sorting of data objects for further analysis and/or application.

In one aspect, an ontology of located/downloaded items may be visually presented (e.g., on a computer screen and/or display device) as a hierarchical graph. Such a hierarchical graph may comprise nodes connected by edges descending from a root node. According to an embodiment, individual nodes in the graph may be electronically linked to a set of data objects maintained in a memory. In one implementation, a child node in the graph descending from a parent node in the graph may be linked to data objects in the memory which are a subset of the data objects in the memory linked to the parent node. The subset of the data objects lined to the child node may be determined according to one or more classification attributes to be defined for the child node.

Terms “ascending” and “descending,” as referred to herein, are to indicate a logical relationship between nodes in a graph connected by one or more edges in the graph according to a hierarchical taxonomy. For example, a parent node in a hierarchical graph may be associated with members of a general set while a child node in the hierarchical graph descending from the parent node may be associated with a more specific subset of members in the general set selected according to some attribute. Terms such as “ascending” or “descending” as relating to a relationship between nodes in a graph are not necessarily to be indicative of a spatial relationship of the nodes in an image of the graph (e.g., on a display device) showing one node placed higher/above another node, or vice versa. For example, a child node connected to a parent node in a hierarchical graph (i.e., the child node logically descending from the parent node according to a hierarchical taxonomy) may be presented in an image as being higher/above the parent.

According to an embodiment, classification attributes to be applied to define nodes in a hierarchical graph may be determined through user interaction with a GUI. For example, through inputs via a GUI, a user may determine classification attributes to be applied to nodes of a graph for populating the nodes with sorted data objects electronically maintained in a memory. A process of defining such classification attributes may be tedious and timing consuming.

According to an embodiment, classification attributes of a predefined hierarchical taxonomy may be maintained in a memory for application to sort electronically stored data objects. In one aspect, user inputs received via a graphical user interface (GUI) integrated with the display device may be used to apply a predefined hierarchical taxonomy to electronically stored data objects to automatically generate one or more child nodes in a hierarchical graph presented on the display device. Each child node may be linked to data objects in the memory which are a subset of the electronically stored data objects according to one or more classification attributes set forth in the predefined hierarchical taxonomy. By maintaining classification attributes of a predefined hierarchical taxonomy in a memory, the predefined hierarchical taxonomy may be reused for application to multiple sets of electronically stored data objects.

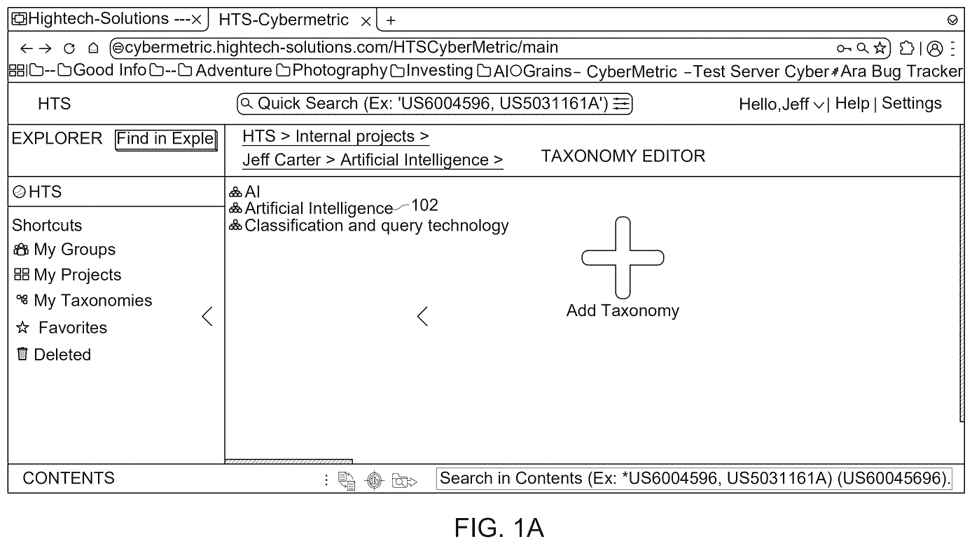

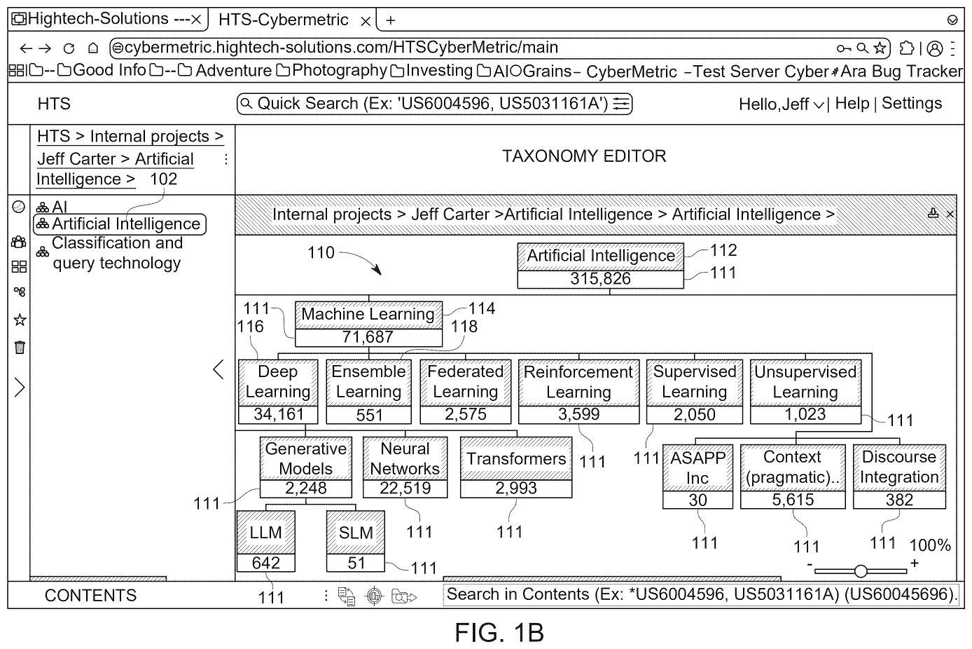

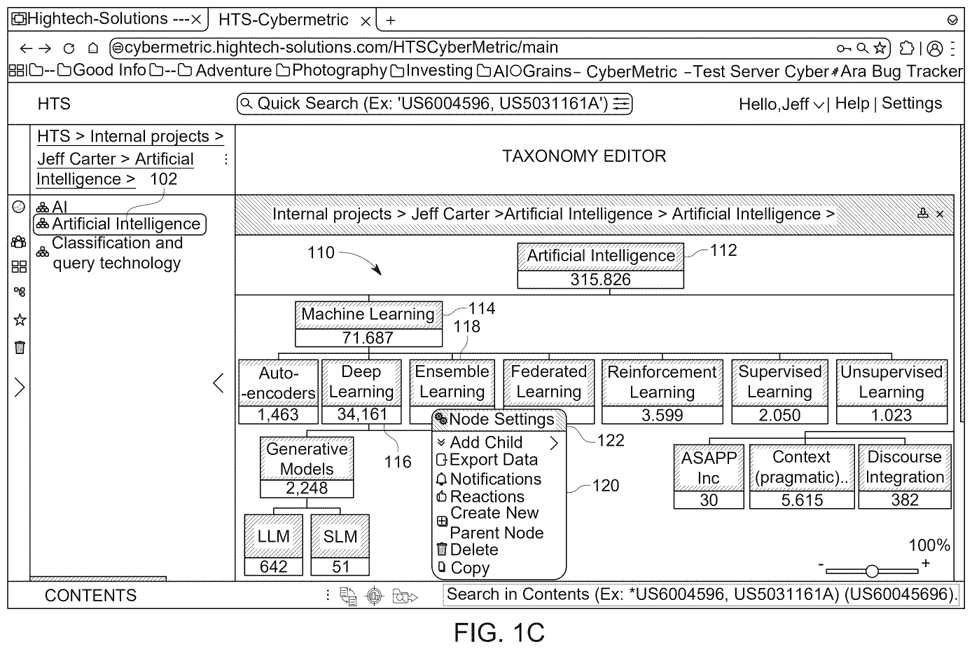

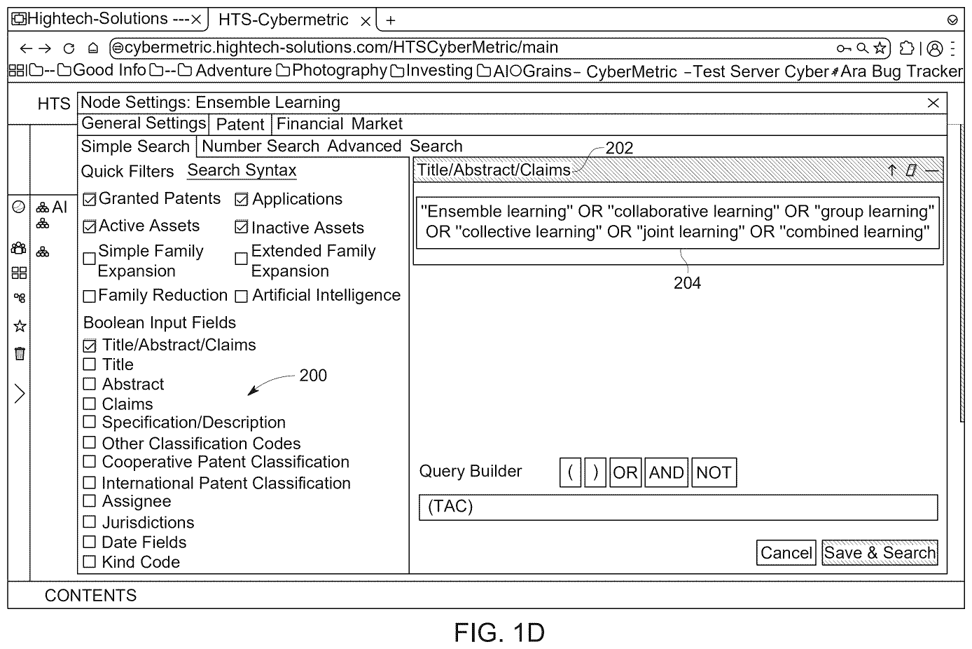

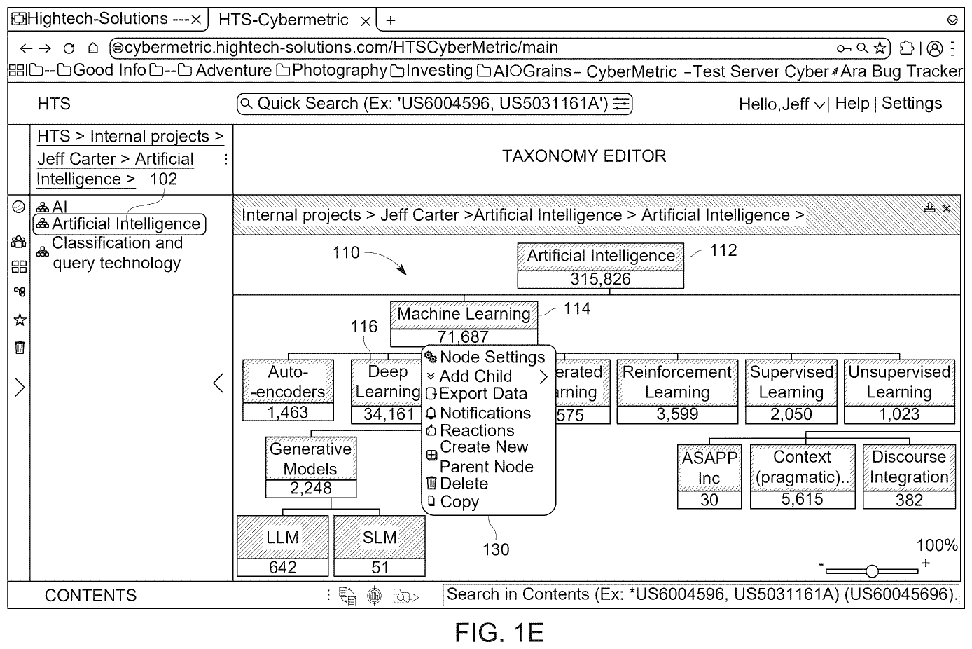

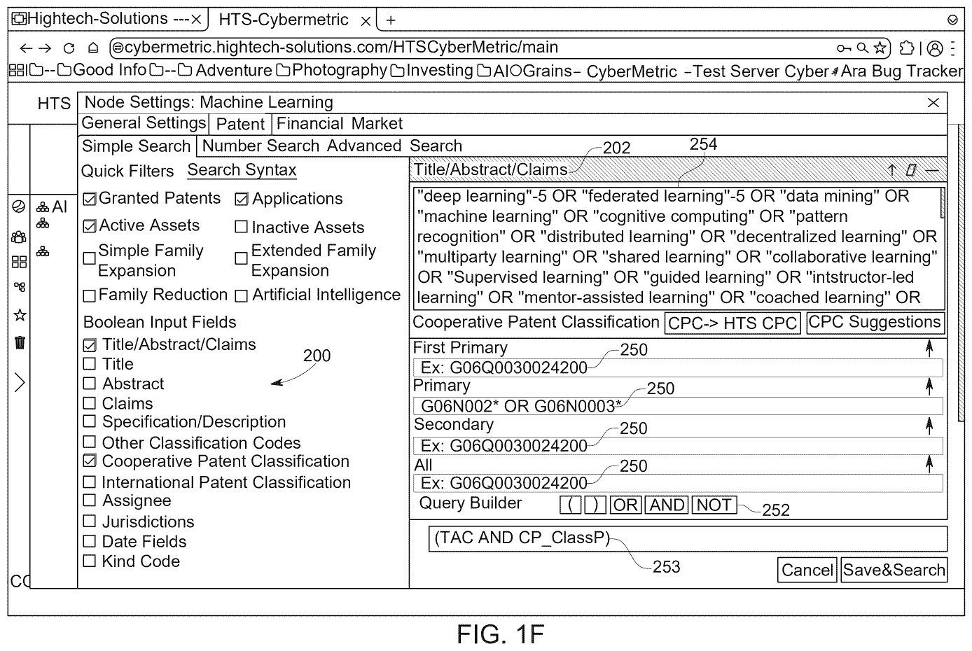

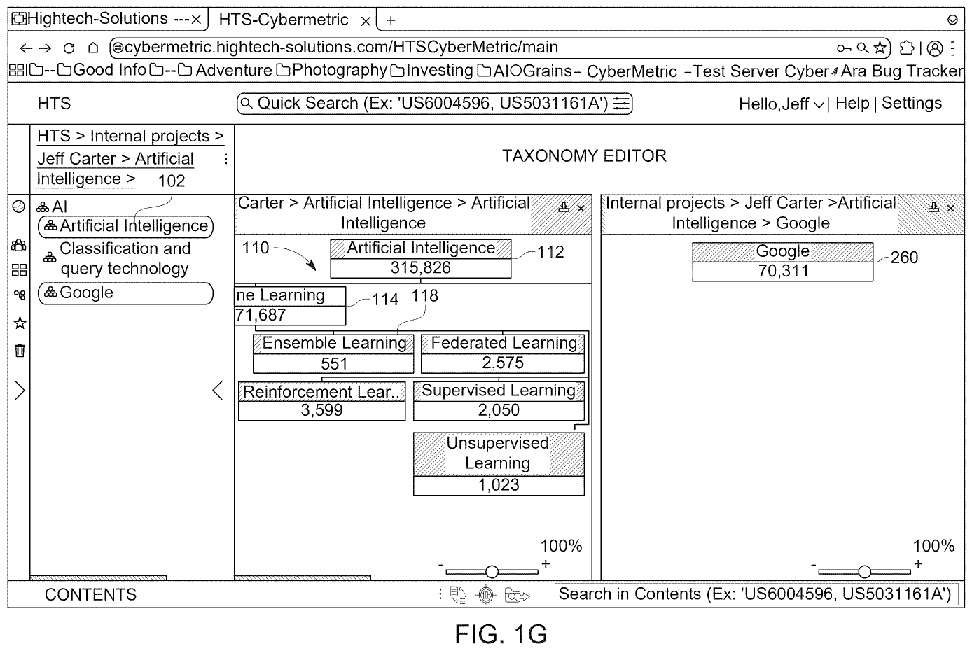

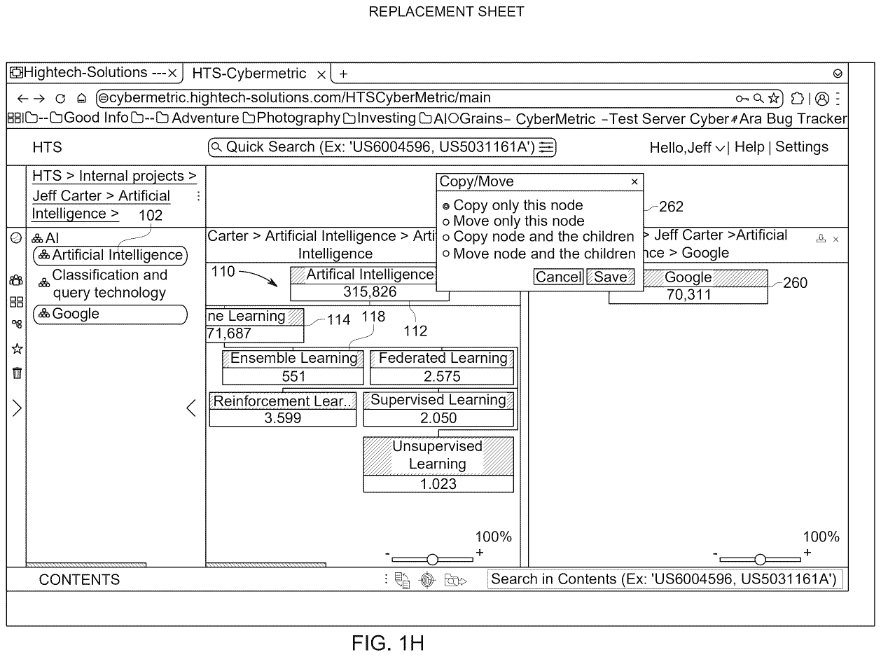

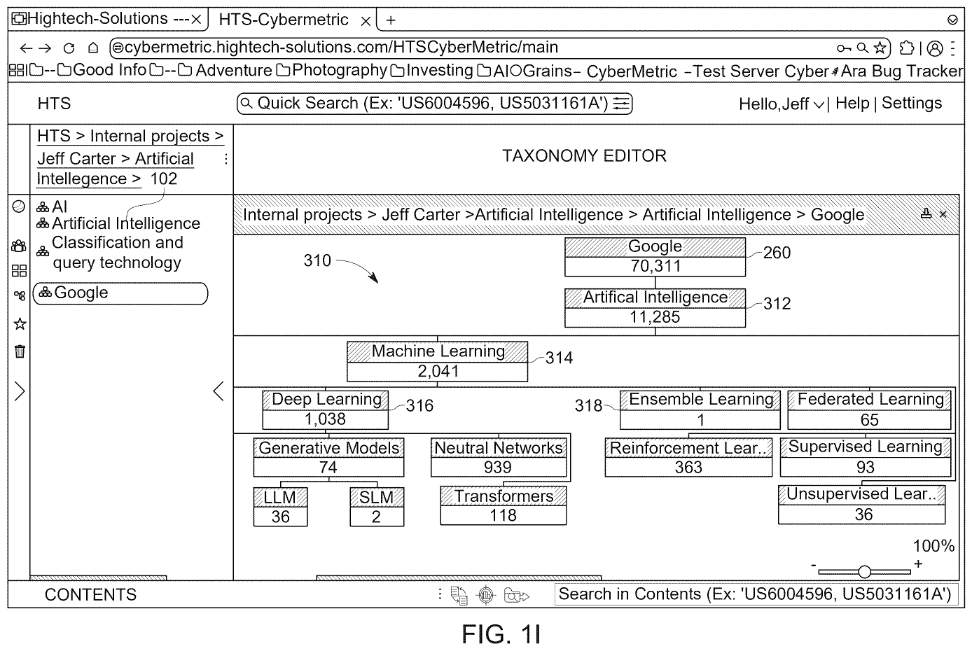

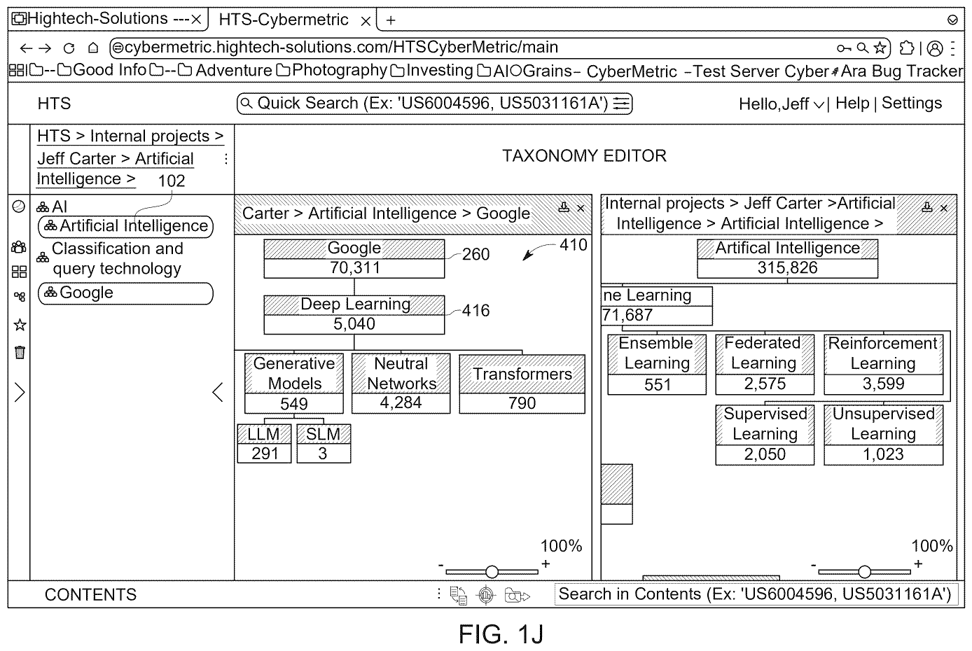

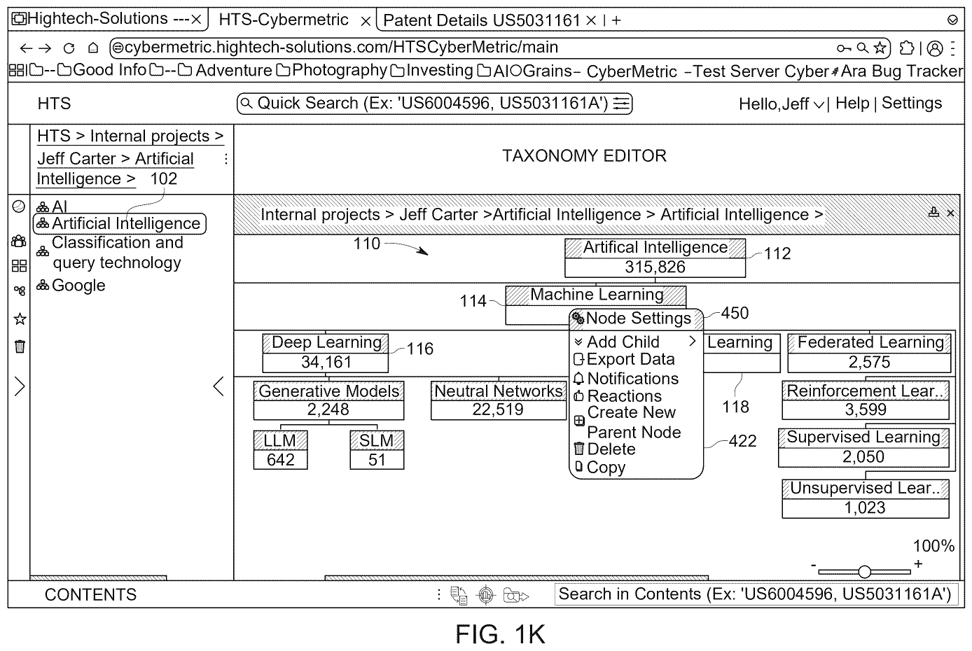

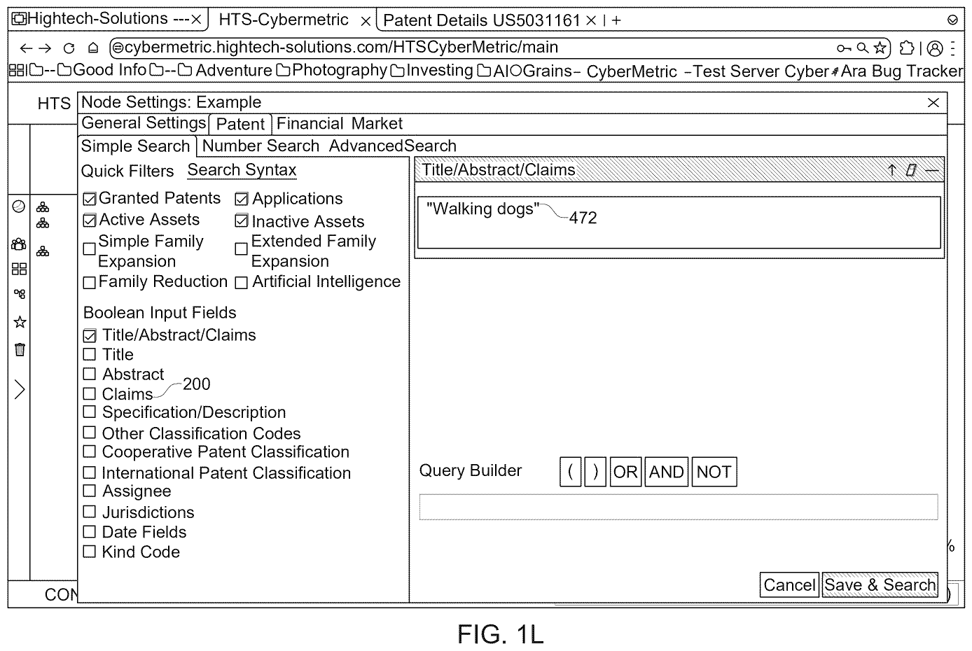

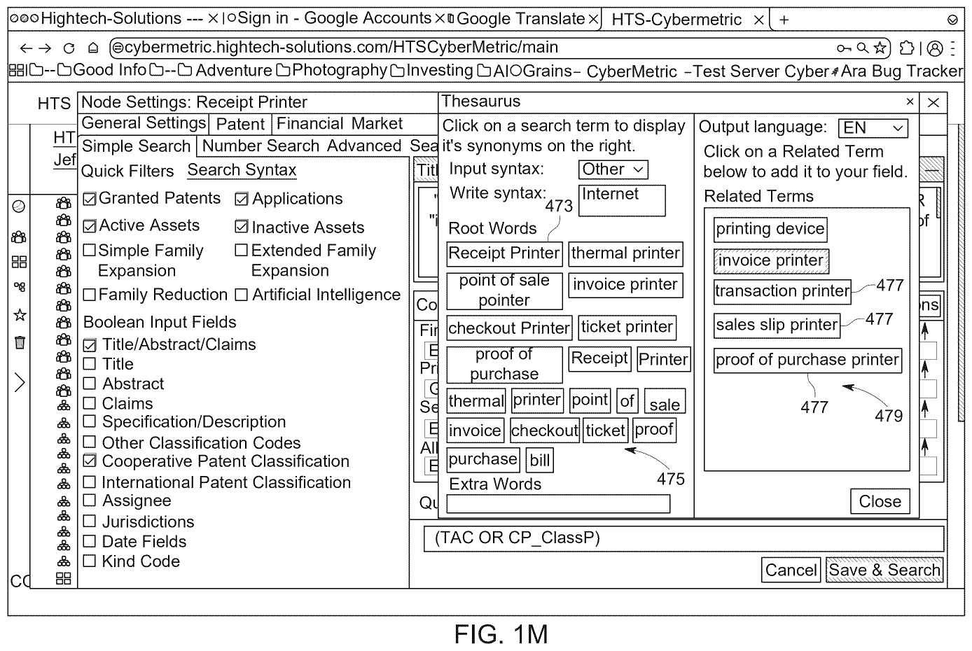

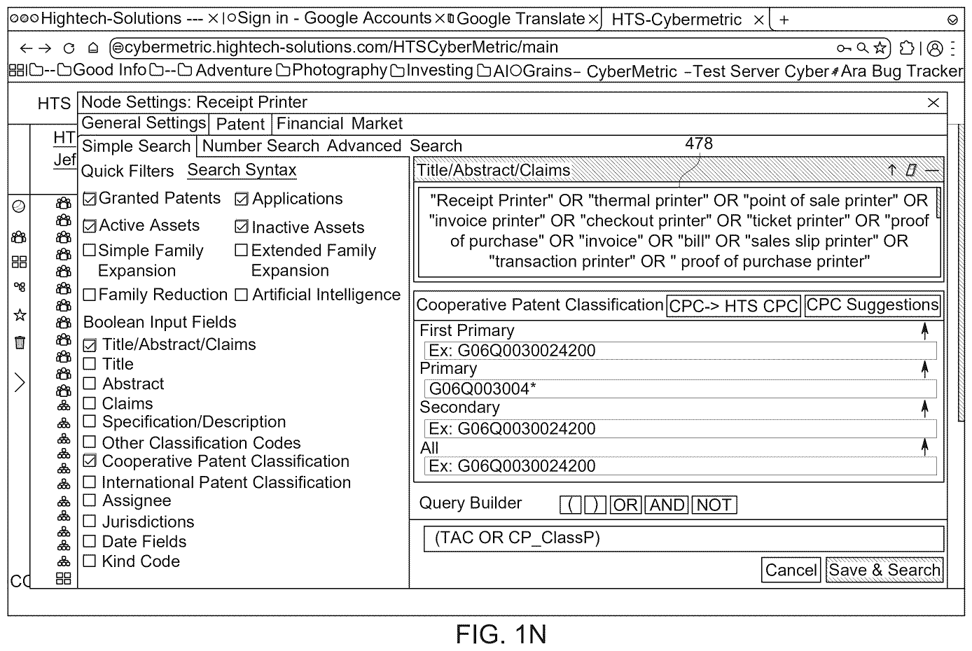

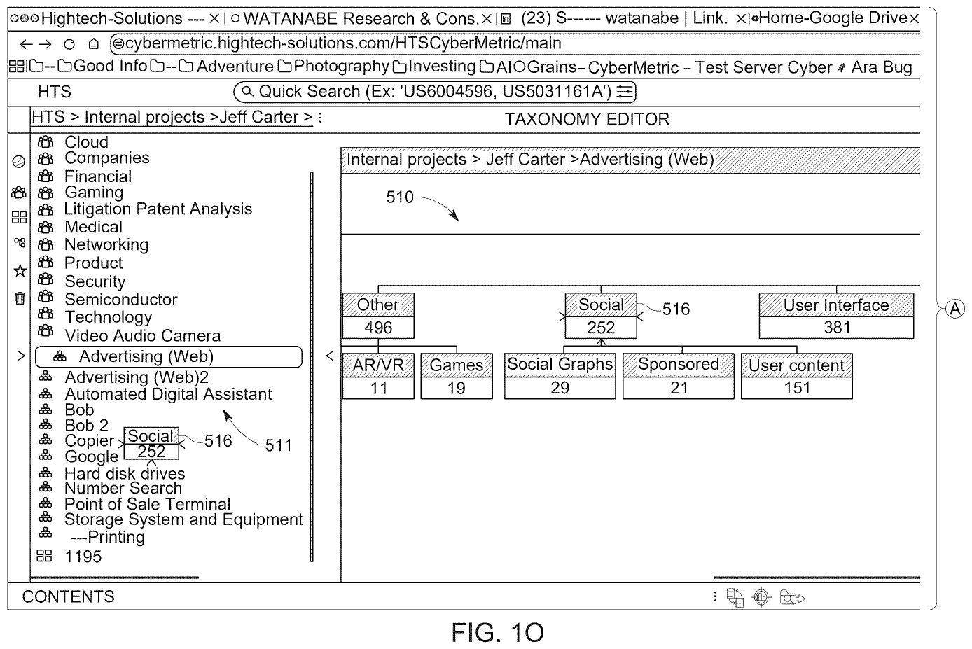

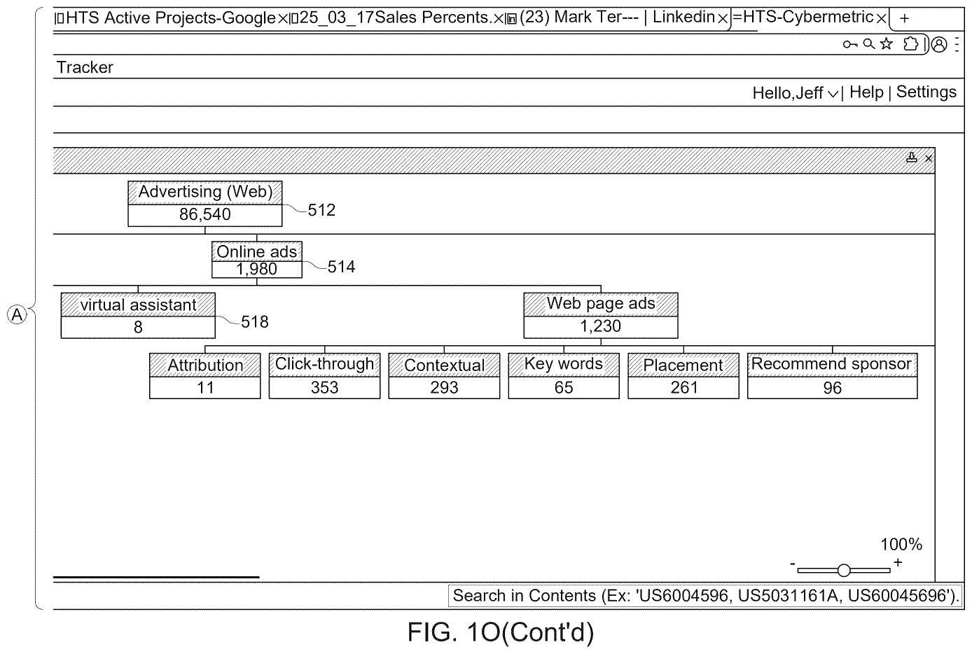

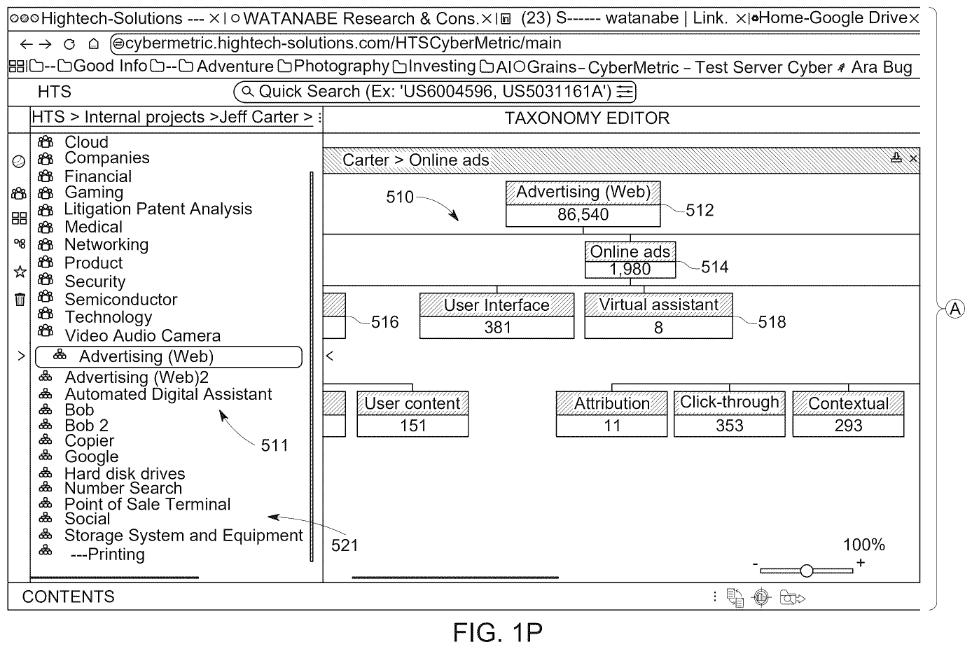

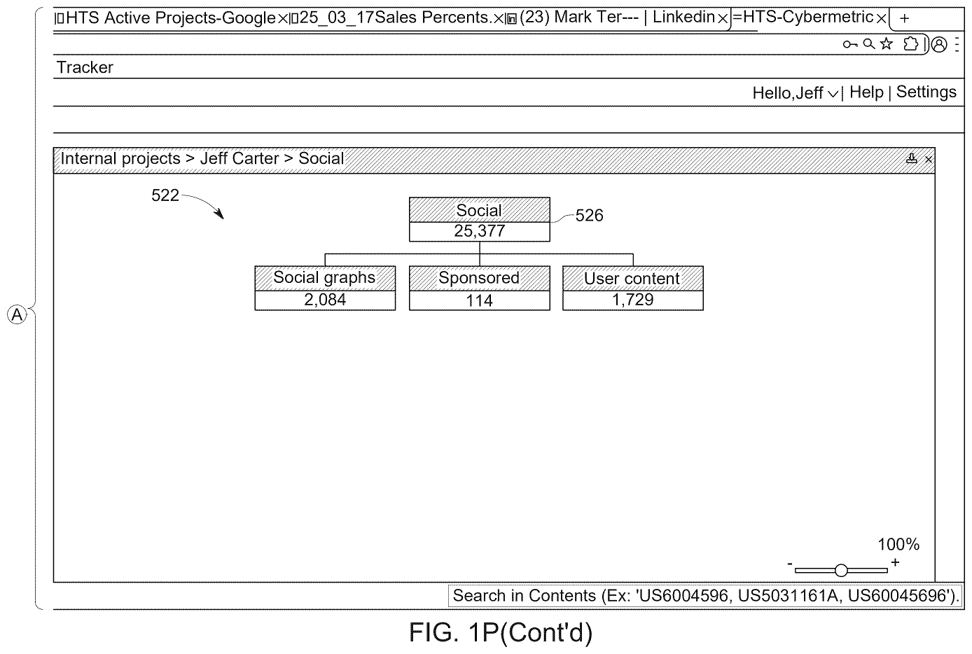

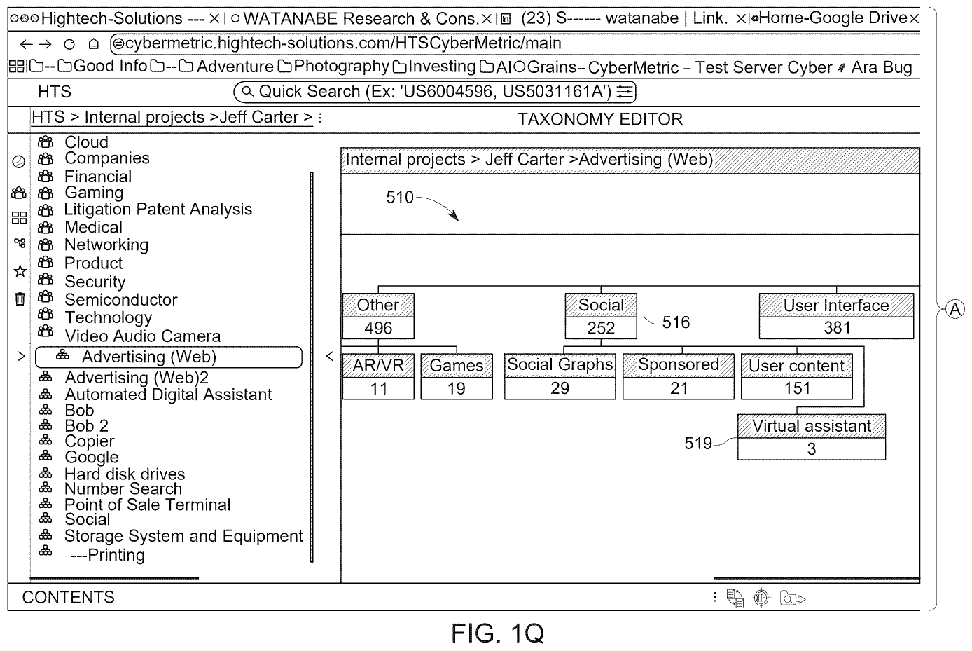

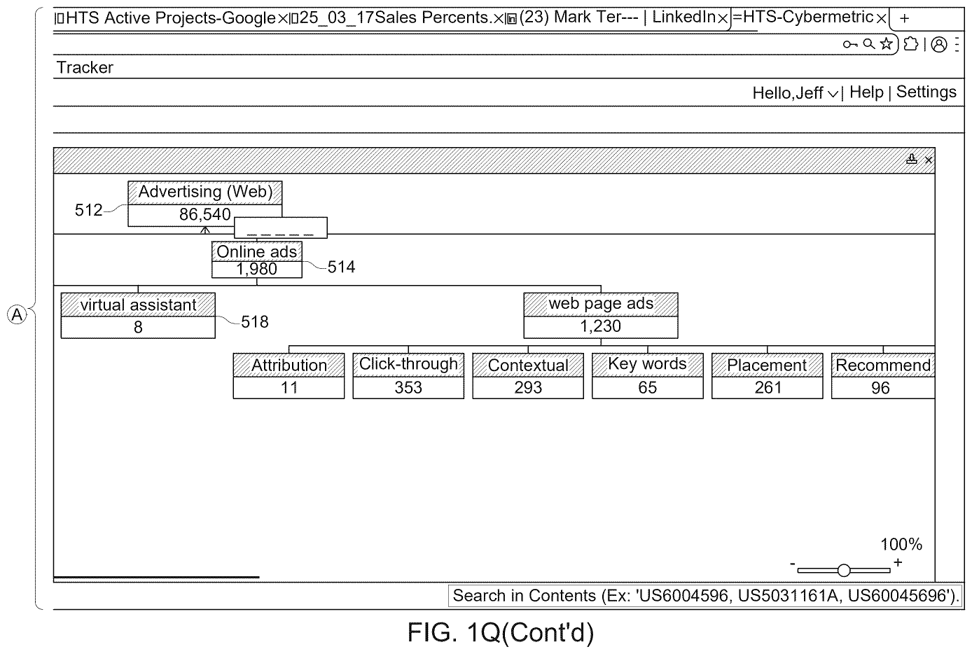

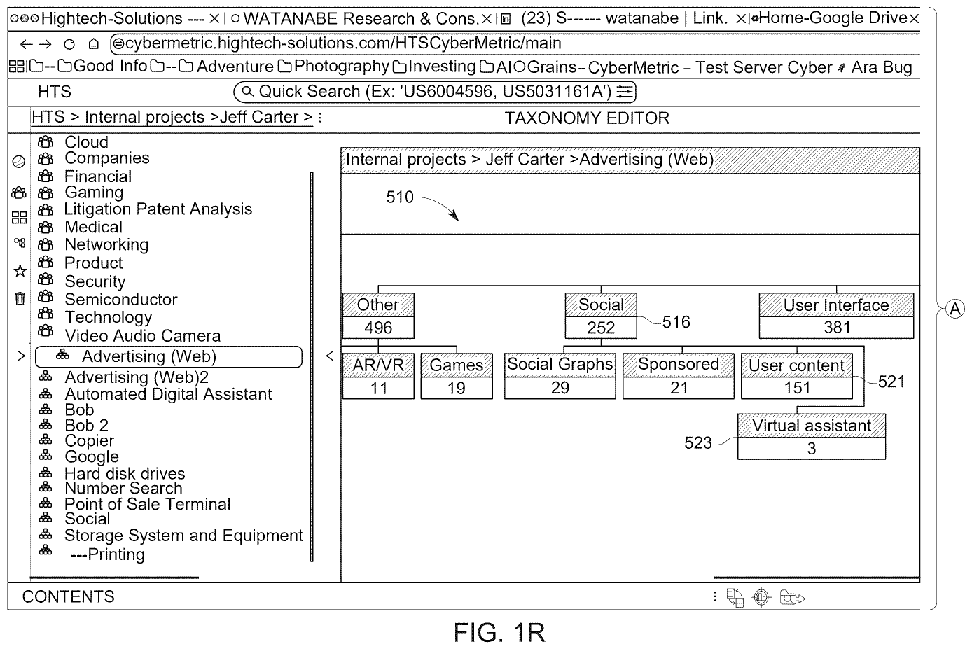

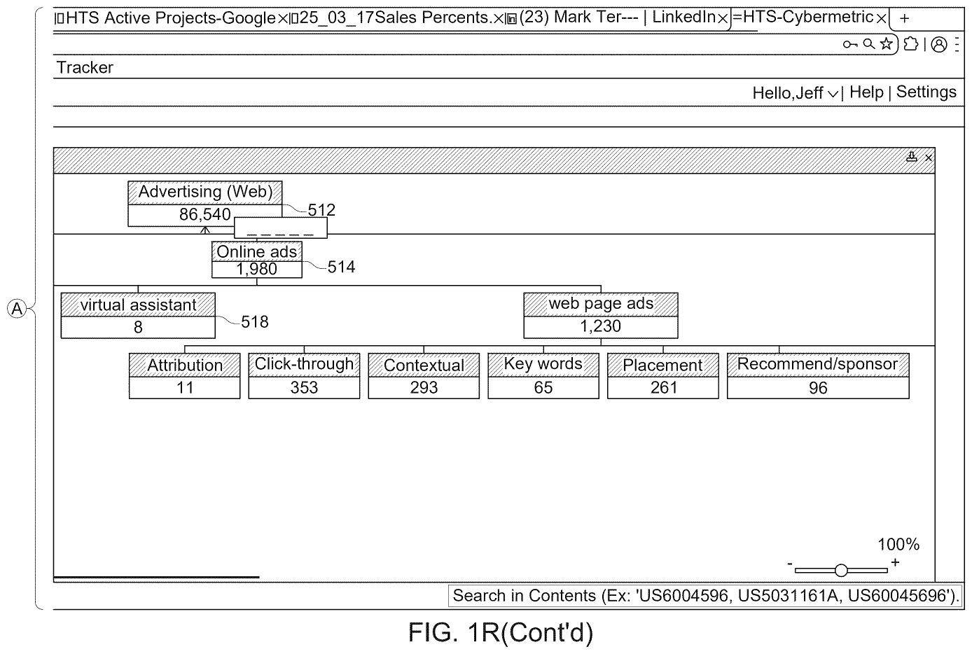

FIGS. 1A through 1R are diagrams of depictions of selections made in a graphical user interface (GUI) for affecting processing of data objects electronically stored in memory for presentation of images on a display device integrated with the GUI, according to embodiments. In some aspects, diagrams depicting a hierarchical graph are presented on a display device integrated with a GUI. According to an embodiment, such a GUI may include executable routines and/or drivers to process user inputs from a pointing device (e.g., mouse, trackball, joystick, touch screen, not shown) and/or other input device (e.g., microphone, camera). For example, such a pointing device may be activated by a user to position a cursor over a particular item in an image presented on a display device. In a particular example, nodes in a hierarchical graph presented on a display device may comprise features that are selectable by placement of a cursor (e.g., using a pointing device) over one of the nodes followed an additional action (e.g., mouse click, pressure on a touchscreen, selection from a trackball or joystick, voice activation etc.).

In an embodiment, a GUI may enable selection of any one of multiple different categories of hierarchical taxonomies for presentation as a hierarchical graph on a display device integrated with the GUI. As shown in FIGS. 1A and 1B, for example, a hierarchical graph 110 may be presented on a display device responsive to selection of “Artificial Intelligence” taxonomy 102. In some embodiments, any one of multiple different taxonomies may be selected such as, for example, financial transactions, social media, web advertisement. In the particular illustrated example, node 112 may form a root node having a taxonomy label “Artificial Intelligence,” which is connected to various child nodes by edges forming hierarchical graph 110. Child nodes in hierarchical graph 110 descending from node 112 include node 114 (descending directly from node 112) having a taxonomy label “Machine Learning,” node 116 (descending directly from node 114) having a taxonomy label “Deep Learning” and node 118 (descending directly from node 114) having a taxonomy label “Ensemble Learning,” among others.

According to an embodiment, hierarchical graph 110 may represent an ontology, taxonomy and/or hierarchical structure of data objects stored in a memory, such as electronic documents maintained in a memory in a suitable format. Here, node 112 is associated with a class of data objects in a classification “Artificial Intelligence.” Nodes in hierarchical graph 110 descending from node 112 are associated with objects in subclassifications of data objects in classification “Artificial Intelligence” represented by node 112. For example, node 114 is to represent data objects in classifications “Artificial Intelligence” and “Machine Learning,” node 116 is to represent data objects in classifications “Artificial Intelligence,” “Machine Learning” and “Deep Learning,” and node 108 is to represent data objects in classifications “Artificial Intelligence,” “Machine Learning” and “Ensemble Learning.”

In addition to having taxonomy labels, nodes in hierarchical graph 110 may also include fields/labels 111 to indicate a count or enumeration of data objects represented by/electronically linked to respective nodes. According to an embodiment, data objects under the classification “Artificial Intelligence” associated with node 112 may comprise publications of patents (e.g., issued U.S. patents) in a particular electronic format (e.g., .pdf, docx, XML). For example, in the presently illustrated embodiment, node 112 may be electronically linked to 315,826 publications of issued U.S. patents as per the associated field/label 111. In an implementation, via selection of node 112 via a GUI, a user may access any of these 315,120 publications (e.g., for copy, download, viewing on a display device). Likewise, node 114 may be electronically linked to 71,687 publications of issued U.S. patents (a subset of the 614,120 publications of issued U.S. patents linked to node 112 relating to “Machine Learning”) similarly accessible via a GUI. Likewise, node 116 may be electronically linked to 34,161 publications of issued U.S. patents (a subset of the 71,687 publications of issued U.S. patents linked to node 114 relating to “Machine Learning”) similarly accessible via a GUI. Likewise, node 118 may be electronically linked to 551 publications of issued U.S. patents (a subset of the 71,687 publications of issued U.S. patents linked to node 114 relating to “Machine Learning”) similarly accessible via a GUI.

In this context, data objects that are “linked to” or “electronically linked to” a node in a graph presented on a display device means that the linked data objects are accessible by a user via interaction with a GUI by selection of the node. Such a selection of a node may be effected, for example, by positioning a cursor over the node in the presented graph, followed by an additional user action (e.g., right or left click of pointing device, pressure on a point of a touchscreen, voice command, etc.). Such a selection of a node may initiate access to data objects linked to the selected node by, for example, presentation of a list of the linked data objects on a display device. Items listed may then be selected for additional access (e.g. presentation of a portion of the selected item on the display device, copying, downloading, etc.).

Data objects electronically linked to a node in a presented graph may be accessed by, for example, presentation of one or more linked data objects on a display device, downloading, etc. In one implementation, data objects electronically linked to nodes in a graph presented on a display device may be stored locally in a memory of a computing device (e.g. system RAM, mass storage non-volatile memory) hosting a GUI integrated with the display device. Here, selection of a presented node in the GUI may initiate application of a local memory address to a software driver to retrieve a linked data object from the memory for access responsive to the selection. In another implementation, data objects linked to nodes in a graph presented on a display may be stored on a remote server computing device. Here, selection of a presented node in the GUI may initiate messages to a web service addressed according to a Universal Resource Indicator (URI) associated with the selected node to request retrieval of all or a portion of data objects linked to the selected node. In one embodiment, data objects linked to a node in a presented graph may be listed in metadata that is stored locally in a memory a computing device hosting a GUI, while the listed data objects may be stored at a remote server accessible via a web service as discussed above. It should be understood, however, that these are merely examples of how a node of a graph presented on a display device integrated with a GUI may be electronically linked to associated data object maintained in a memory, and claimed subject matter is not limited in this respect.

The particular examples illustrated in FIGS. 1A through 1N are directed to hierarchical graphs with nodes electronically linked to data objects comprising publications of issued U.S. patents as examples of data objects comprising text fields. In other embodiments, nodes in a hierarchical graph may be electronically linked to other/different data objects comprising text fields such as, for example, technical publications, technical standards (e.g., cellular telephony standards, WiFi standards, video standards, etc.) news articles, just to provide a few examples. In yet other embodiments, nodes in a hierarchical graph may be electronically linked to data objects of other types of content such as images stored in an electronic and/or compressed format (e.g., video files), audio content, raw sensor data, just to provide a few examples.

According to an embodiment, nodes in hierarchical graph 110 may be defined by one or more classification attributes to be applied in selecting members of a subset of data objects to be linked to respective nodes in hierarchical graph 110. In an implementation, a child node in hierarchical graph 110 may be electronically linked to selected members of the set of data objects linked to a parent node connect to the child node by an edge in hierarchical graph 110. The selected members of the set of data objects stored in a memory and electronically linked to the child node are determined based, at least in part on classification attributes defined for/defining the child node. For example, node 114 may be electronically linked to selected members of the 315,120 data objects electronically linked to node 112 selected according to classification attributes defined for node 114. Likewise, node 116 may be electronically linked to selected members of the 71,687 data objects electronically linked to node 114 selected according to classification attributes defined for node 116. Likewise, node 118 may be electronically linked to selected members of the 71,687 data objects electronically linked to node 114 selected according to classification attributes defined for node 118.

According to an embodiment, classification attributes defining a particular node (e.g., for selection of data objects to be electronically linked to a parent node to be electronically linked to the particular nodes) may be implemented as any particular feature and/or attribute that is applicable to content in a data object electronically linked to a node in a hierarchical graph. In an implementation in which data objects include portions of text (e.g., in a publication of an issued U.S. patent), such a feature and/or attribute may comprise text/key words in selected fields. In another embodiment in which data objects linked to a node include electronic/compressed images, audio content and/or raw sensor data, for example, classification attributes may define the node may include feature maps for application in general detection schemes. In an embodiment, a classification attribute be defined, at least in part, by a database field such as a date, assignee, title, or abstract setting out a particular criteria.

In another embodiment, one or more classification attributes defining a hierarchical graph may be expressed as a vectorized representation of a portion of text (e.g., assortment of words or phrases, one or more sentences, one or more paragraphs, etc.). In a particular implementation, such a vectorized representation may be formed using machine learning-based techniques for contextually vectorizing text. In applying such a vectorized representation, data objects of interest (e.g., data objects with text fields) may be similarly vectorized to enable computation of a “distance” (e.g., according to a vector space) between the classification attributes (in vectorized form) and vectorized data objects. Vectorized data objects within a particular “distance” of the classification attributes may then be electronically linked to associated node in a hierarchical graph accordingly. In another particular embodiment, a vectorized representation of a portion of text may be applied as a Boolean variable to be logically combined with other Boolean variables in a Boolean expression that is to express classification attributes defining a node in a hierarchical graph. For example, such a Boolean variable may have a value of “True” if a vectorization of a portion of a data object is determined to be within a distance of vectorized classification attributes. Conversely, such a Boolean variable may have a value of “False” if the vectorization of the portion of the data object is determined to be outside of a distance of the vectorized classification attributes.

As pointed out above in a particular example, data objects linked to a parent node may comprise publications of issued U.S. patents. Here, in one example, classification attributes defining a child node descending from the parent node may include combinations of terms/words found in particular fields applicable to publications of issued US patents. Such particular fields may include, for example, claims, description, title, abstract, assignee, inventor name, just to provide a few examples particular fields of a data object linked to the parent node. In another example, classification attributes defining a child node descending from a parent node electronically linked to publications of US patents may include patent/technology classification codes.

According to an embodiment, classification attributes defining a node in hierarchical graph 110 may be constructed, at least in part, as a Boolean expression that is applicable to select members of a set of data objects electronically linked to a parent node connected to the defined node by an edge in hierarchical graph 110. For example, such a Boolean expression may comprise combinations text/words, other content features and/or classification codes that are associated by Boolean operators such as “and,” “or,” “xor,” ∪, ∩, ∧, ∨, just to provide a few examples of Boolean operators that may be used for combining elements in a Boolean expression to be applied to content of a data object and/or metadata of such a data object.

According to an embodiment, classification attributes defining a node in hierarchical graph 110 presented on a display device may be established, updated, modified, edited, etc. through interaction with a GUI integrated with the display device. As shown in FIG. 1C, for example, selection of node 118 in the GUI may initiate presentation of a drop-down menu 120 (e.g., by positioning a cursor over node 118 with a pointing device while right or left clicking the pointing device). Items in drop-down menu 120 may enable modification to aspects of node 118 such as, for example, changing node settings, adding a child node, exporting data (e.g., exporting data objects linked to node 118), deletion or copying. Further selection of node settings 122 in drop-down menu 120 may initiate presentation of fields showing classification attributes defining node 118 and enabling modification of such classification attributes via interaction with the GUI as shown in FIG. 1D.

Menu 200 as shown in FIG. 1D may enable selection of particular portions/fields of data objects to which classification attributes defining node 118 are to be applied (e.g., for selecting data objects electronically linked to node 118 from data objects linked to a parent node of node 118). In this particular example, menu 200 identifies fields/portions that are relevant to data objects comprising publications of issued US patents. It should be understood, however, that different fields/portions may be identifiable in such a menu for different types of data objects. Here, only “Title/Abstract/Claims” is selected in menu 200, to indicate that classification attributes defining node 118 are to be applied to Title, Abstract or Claims portions of data objects electronically linked to a parent node (e.g., node 114) for determining the subset of data objects (e.g., subset of data objects in a memory electronically linked to node 114) to be electronically linked to node 118. Field 204 shows an example Boolean expression setting forth classification attributes to define node 118, and to be applied to Title, Abstract or Claims portions of data objects linked to a parent node for selection of data objects (e.g., data objects in a memory electronically linked to a parent node connected to and/or ascending from node 118) to be linked to node 118.

Similar to initiation of presentation of drop-down menu 120, drop-down menu 130 may be initiated by selection of node 114 as shown in FIG. 1E. Selection of “node settings” in drop-down menu 130 may initiate presentation of fields showing classification attributes defining node 114, and enabling modification of such classification attributes via interaction with a GUI as shown in FIG. 1F. Here, “Patent Cooperation Classification” is selected in menu 200, in addition to selection of “Title/Abstract/Claims”, to indicate how classification attributes defining node 114 are to be applied to data objects electronically linked to a parent node (e.g., node 112). Selecting “Patent Cooperation Classification” may enable specifying class attributes according to national and/or international technology classification codes. According to an embodiment, a Boolean expression in field 254 may be logically combined in a Boolean expression to provide classification attributes defining a node. In the particular example illustrated in field 253 for classification attributes defining a node, Boolean expression of field 254 (denoted as “TAC”) is logically combined with classification codes in fields 250 (denoted as “CP_ClassP”) by a Boolean “AND” operator. In other examples (not shown), classification attributes may be expressed as Boolean expression of field 254 combined with classification codes in fields 250 by a different Boolean operator (e.g., OR, NOR, XOR, NAND, etc.). In other embodiments, Boolean variables based on a vectorized distance (e.g., as discussed above) may be logically combined with other Boolean variables in a Boolean expression specified in field 253.

According to an embodiment, classification attributes defining any node of hierarchical graph 110 may be presented and/or modified as shown in 1C though 1F and described in the accompanying text. In one implementation, classification attributes of nodes in hierarchical graph 110, and hierarchical association of these classification attributes, may be abstracted and separately maintained in a data structure to express a hierarchical taxonomy. For example, for each node in hierarchical graph 110, such a data structure may maintain Boolean expressions (e.g., Boolean expressions shown in fields 204 and/or 254) and other classification attributes (e.g., class codes in fields 250). Such a data structure may also delineate classification attributes defining nodes in hierarchical graph 110 are to be hierarchically related. In an implementation, a data structure maintaining an abstracted hierarchical taxonomy of a hierarchical graph may include for each node fields/records to represent classification attributes defining the node. Fields/records to represent classification attributes defining nodes may then be associated in a data structure with pointers and/or handles to represent parent/child relationships between/among nodes according to edges in the hierarchical graph.

According to an embodiment, an abstracted hierarchical taxonomy of hierarchical graph 110 expressed in a data structure may be maintained in a library stored in a memory along with data structures of other hierarchical taxonomies applicable to a set of data objects. For example, data structures to express multiple different abstracted hierarchical taxonomies electronically maintained in a memory may be retrievable/selectable for use via interaction with a GUI for application to a user selected set of data objects. As shown in FIG. 1G, a node 260 that is separate and distinct from hierarchical graph may be electronically linked to 70,314 publications of issued U.S. patents which have been assigned to Google. As shown in FIGS. 1H and 1G, via inputs received via a GUI, root node 112 of hierarchical graph 110 may be “copied” and applied to node 260 to present a new hierarchical graph 310 shown in FIG. 1I. In one embodiment, root node 112 of hierarchical graph 110 may be “copied” and applied to node 206 via a copy and paste operation. In another embodiment, root node 112 of hierarchical graph 110 may be “copied” and applied to node 206 using a drag-and-drop operation.

According to an embodiment, as shown in FIG. 1J, copying and applying node 112 to node 260 in an operation using a GUI may initiate presentation of hierarchical graph 310. For example, copying and applying node 112 to node 260 may comprise application of an abstracted hierarchical taxonomy of hierarchical graph 110 expressed in a data structure (e.g., maintained in a memory) to data objects electronically linked to node 260. In an implementation, nodes in hierarchical graph 310 may be linked to associated subsets of data objects electronically linked to node 260. Data objects electronically linked to nodes in hierarchical graph 310 may be selected from data objects electronically linked to node 260 according to classification attributes defining corresponding nodes of hierarchical graph 110 (e.g., according to an abstracted hierarchical taxonomy expressed in a data structure). For example, data objects electronically linked to node 312 may comprise data objects linked to node 260 that are selected according to “Artificial Intelligence” classification attributes defining node 112 (in hierarchical graph 110). Similarly, data objects electronically linked to node 314 may comprise data objects electronically linked to node 260 that are selected according to “Artificial Intelligence” classification attributes defining node 112 and “Machine Learning” classification attributes defining node 114 (in hierarchical graph 110). Likewise, data objects linked to node 318 may comprise data objects electronically linked to node 260 that are selected according to “Artificial Intelligence” classification attributes defining node 112, “Machine Learning” classification attributes defining node 114 and “Ensemble Learning” classification attributes defining node 118 (in hierarchical graph 110). Likewise, data objects electronically linked to node 316 may comprise data objects electronically linked to node 260 that are selected according to “Artificial Intelligence” classification attributes defining node 112, “Machine Learning” classification attributes defining node 114 and “Deep Learning” classification attributes defining node 116 (in hierarchical graph 110).

In one implementation, applying copied node 112 to node 260 may initiate an electronic search of data objects electronically linked to node 260 to locate data objects having classification attributes defining node 112 so that the located data objects may be electronically linked to node 312. Of data objects linked to node 260 having classification attributes defining node 112, additional searches may be performed to locate data objects to be electronically linked to nodes in hierarchical graph 310 that are connected to node 312 by edges (e.g., nodes 314, 316 and 318).

In the particular example of FIGS. 1H and 1I, a root node 112 was copied and applied to node 260 to initiate presentation of hierarchical graph 310 in a display device. Hierarchical graph 310 shows application of classification attributes defining node 112, and classification attributes defining all nodes in hierarchical graph 110 descending from node 112 (e.g., from a data structure maintaining an abstracted hierarchical taxonomy in a memory). In another embodiment as shown in FIG. 1J, a non-root node 116 of hierarchical graph 110 may be copied and applied to node 260 to present a hierarchical graph 410 according to an application of classification attributes defining node 116, and classification attributes of all nodes in hierarchical graph 110 descending from node 116 (e.g., from a data structure to express a portion of a hierarchical taxonomy abstracted from hierarchical graph 110). Here, node 416 may be linked to a subset of data objects linked to node 260 selected according to “Deep Learning” classification attributes defining node 116 (irrespective of any “Artificial Intelligence” classification attributes defining node 112 or “Machine Learning” classification attributes defining node 114). As mentioned above, an abstracted hierarchical taxonomy of hierarchical graph 110 may be maintained in a data structure stored in a memory (e.g., for selection and application). Copying and applying node 116 to node 260 may comprise application of a selected/limited portion of an abstracted hierarchical taxonomy of hierarchical graph 110 (e.g., maintained in a memory) limited to classification attributes of node 116, and of nodes in hierarchical graph 110 descending from node 116.

As shown in the embodiments of FIGS. 1O and 1P, a GUI integrated with a display device may process user inputs to select a child node in hierarchical graph 510 presented in the display device to create/spawn a new hierarchical graph 522 to be presented in the display device. Here, the GUI may process inputs to copy and/or drag and drop node 516 labeled “Social” to a menu/taxonomy library 511. Responsive to copying node 516 to menu/taxonomy library 511, the display device may present hierarchical graph 522 having a root node 526 corresponding to copied node 516. Hierarchical graph 522 includes nodes descending from root node 526 corresponding to nodes in hierarchical graph 510 descending from copied node 516.

In the particular illustrated embodiment, hierarchical graph 510 shows a hierarchical taxonomy of a corpus of publications of issued US patents that directed to “Advertising (web)” according to classification attributes defining node 512. Of data objects in the corpus, node 512 is electronically linked to 86,540 stored in memory. Of the 86,540 data objects electronically linked to node 512, node 516 labeled “Social” is electronically linked to 252 as a subset of 86,540 data objects electronically linked to node 512 that further meet classification attributes defining node 514 labeled “Online Ads” and classification attributes defining node 516. In the particular illustrated embodiment, root node 526 (labeled “Social” and defined by classification attributes defining copied node 516) is electronically linked to 25,377 data objects stored in memory. Here, the 25,377 data objects linked to node 526 are selected as a subset of the larger corpus (e.g., publications of issued US patents) from application of classification defining node 526 (from classification attributes of copied node 516 in hierarchical graph 510), without any regard for classification attributes defining nodes 512 or 514 in hierarchical graph 510. Child nodes in hierarchical graph 522 descending from node 526 are similarly linked to respective subsets of data objects electronically linked to node 526 selected according to classification attributes defining respective nodes in hierarchical graph 510 descending from node 516.

As shown in the embodiments of FIGS. 1Q and 1R, a GUI integrated with a display device may process user inputs to select and copy node 518 hierarchical graph 510 to other nodes to create to other a child node in hierarchical graph 510. Node 518 labeled “Virtual Assistant” is electronically linked to eight data objects selected from data objects electronically linked to node 514 according to classification attributes defining node 514. As shown in FIG. 1Q, node 518 may be selected and copied to node 516 to spawn a new node 519 linked to three data objects selected from data objects linked to node 516 according to classification attributes defining copied node 518. Similarly as shown in FIG. 1R, node 518 may be selected and copied to node 521 to spawn a new node 523 linked to three data objects selected from data objects linked to node 521 according to classification attributes defining copied node 518.

Particular embodiments described with reference to FIGS. 1C through 1F are directed to presentation and/or modification of classification attributes defining nodes in hierarchical graph 110 according to Boolean expressions and/or specified class codes. In another embodiment, classification attributes defining a node in hierarchical graph 110 may be defined, at least in part, from terms generated by a generative machine learning model such as a generative neural network model. As shown in FIGS. 1K and 1L, selection of node settings 450 in a drop-down menu 422 for node 114 (e.g., initiated from selection of node 114 in a GUI using a pointing device as described above) may present a field 472 to specify a Boolean expression for selection of data objects linked to a parent node. According to an embodiment, initial terms/words that are selected for/written into field 472 may be used for spawning additional terms for specifying a Boolean expression to provide classification attributes defining a node in a hierarchical graph. As shown in FIG. 1M, a node labeled “Receipt Printer” in a hierarchical graph may be selected for “node settings” (e.g., as shown by selection of node settings 122 in drop-down menu 120 above) and a thesaurus pane may be selected to show a parsing 475 of terms in a field showing a Boolean expression that logically combines these terms. Of these terms, “Receipt Printer” may be selected at 473 via inputs received from a GUI to generate related terms 479. In a particular implementation, related terms 479 may be generated, at least in part, on a prompt to a generative neural network model. Such a generative neural network model may be accessed, at least in part, via a web service that accepts parsed terms 475 and selection 473 of term “Receipt Printer” as a prompt, and generates terms 479 as a response to the prompt. One or more of the terms 476 may then be selected for incorporation in a Boolean expression for classification attributes defining the “Receipt Printer” node. As shown in FIG. 1N, terms 477 (“transaction printer,” “sales slip printer” and “proof of purchase printer”) may be selected from among generated terms 479 to expand on terms in field 478 in a Boolean expression to more broadly cast classification attributes based on “Receipt Printers.”

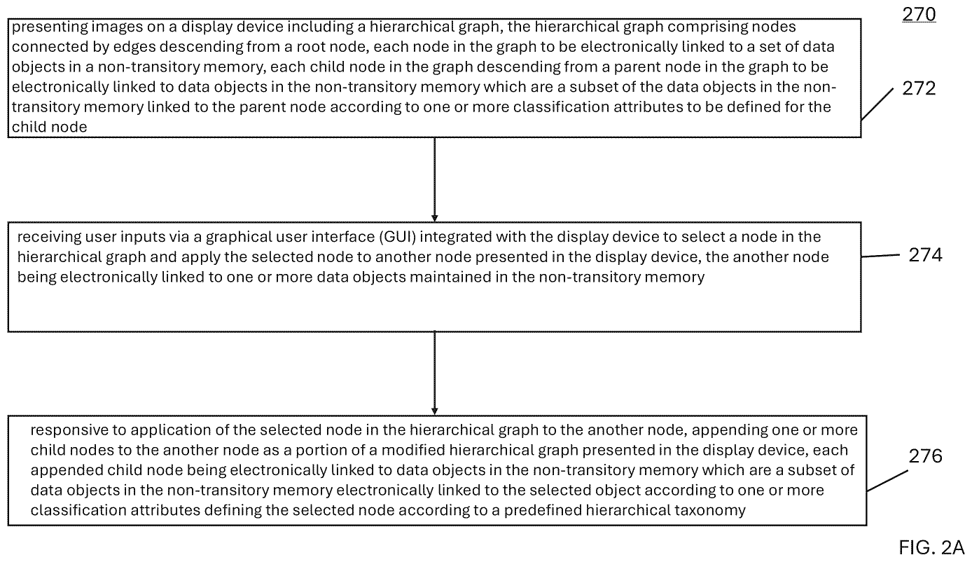

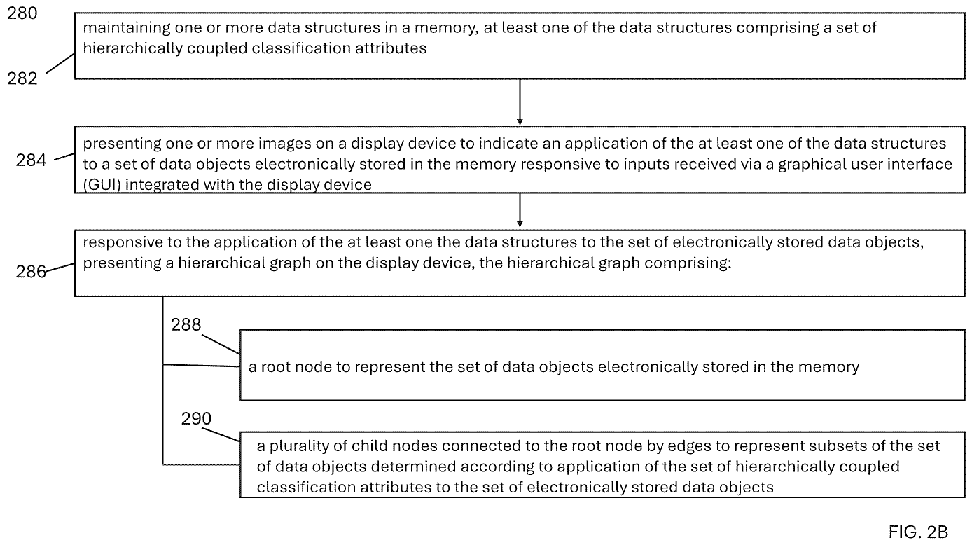

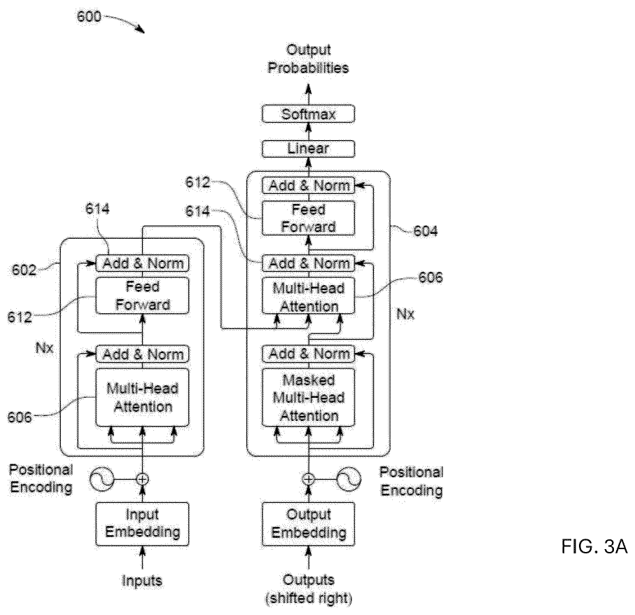

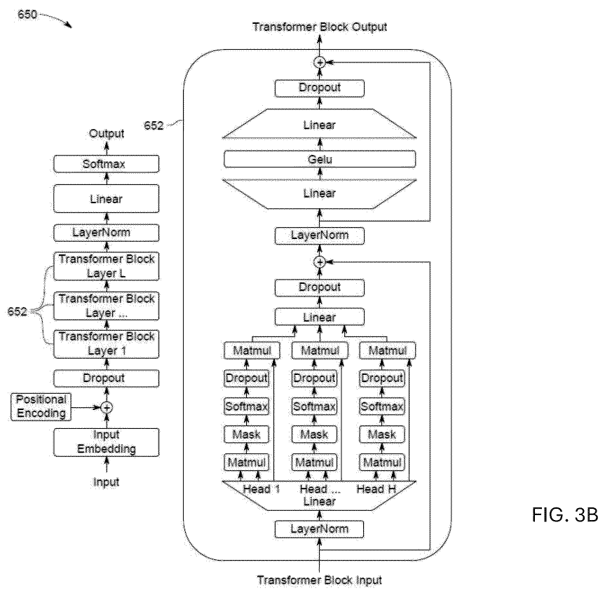

FIG. 2A is a flow diagram of a process 270 for processing inputs received at a GUI for presenting aspects of hierarchical graph in a display device integrated with the GUI, according to an embodiment. Block 272 is directed to presentation of a hierarchical graph in a display device such as hierarchical graph 110 including nodes connected by a root node such as node 112. As pointed out above, nodes in a hierarchical graph may be electronically linked to one or more data objects maintained in a memory such as by addresses to data objects stored locally or on a remote server that is accessible via a web service according to a URI, for example. Of the set of data objects electronically linked to a root node in the hierarchical graph, nodes descending from the root node are electronically linked to subsets according to a hierarchical taxonomy characterized by classification attributes defining the descending nodes.

At block 274, user inputs received via a GUI may effect selection of a node in the hierarchical graph to apply at least a portion of the hierarchical taxonomy characterized by classification attributes defining nodes of the hierarchical graph presented at block 272 to another node (e.g., another node in the same or different hierarchical graph) presented in the display device. In one implementation, the another node may comprise a single node (e.g., node 260) representing a set of data objects maintained in a memory electronically linked to the single node. In another implementation, the another node may comprise any node in a hierarchical graph presented in the display device (e.g., node in the hierarchical graph referred to in block 272 or node in a second hierarchical graph presented in the display device).

Responsive to application at block 274 of the selected node to the another node, block 276 may append one or more child nodes to the node as part of a modified hierarchical graph presented in the display device. In one implementation, such a modified hierarchical graph may comprise a second hierarchical graph extending from a single node such as child nodes appended to node 260 in hierarchical graph 310 from application of node 112 in hierarchical graph 110 (FIGS. 1G, 1H and 1I). In another implementation, the another node may comprise a second selected node in the hierarchical graph referenced in block 272, and the modified hierarchical graph may comprise modification of that hierarchical by appending child nodes to the second selected node.

FIG. 2B is a flow diagram of a process 280 for processing inputs received at a GUI for presenting aspects of hierarchical graph in a display device integrated with the GUI, according to an embodiment. Block 282 may comprise maintaining one or more data structures in a memory to express a hierarchical taxonomy according to classification attributes defining hierarchically coupled nodes. As pointed out above, such a data structure may comprise classification attributes abstracted and separately maintained in a data structure to express a hierarchical taxonomy of a hierarchical graph presented on the display device.

Responsive to inputs received via the GUI, block 284 may comprise presentation of one or more images on the display device to indicate application of classification attributes of the at least one of the data structures to a set of data objects electronically stored in a memory. Such application of classification attributes of the at least one of the data structures may comprise application of classification attributes of a hierarchical graph (e.g., classification attributes abstracted from individual nodes of hierarchical graph 111) to another object presented in the display device (e.g., node 260). Block 286 may then comprise presentation of a resulting hierarchical graph comprising a root node (block 288) and a plurality of child nodes connected to the root node by edges (block 289). In one embodiment, the data structure expressing the hierarchical taxonomy and the set of data objects may be stored in the same memory device (e.g., system memory, non-volatile mass storage memory). In another embodiment, the data structure expressing the hierarchical taxonomy and the set of data objects may be stored on different memory devices.

According to an embodiment, block 284 may comprise presentation on a display device of a discriminator hierarchical graph comprising a root discriminator node and child discriminator nodes connected to the root discriminator node. Each of the child discriminator nodes may represent a hierarchically coupled classification attribute and/or discriminator of the set of hierarchically coupled classification discriminators. Via user inputs to a GUI, a root discriminator node may be dragged and on an image representing the set of data objects electronically stored in the memory (e.g., application of classification attributes of node 112 to node 260 as shown in FIGS. 1G, 1H and 1I). A modified and/or new hierarchical graph may then be presented on the display device responsive to dropping the root discriminator node on the image representing the set of data objects electronically stored in the memory. In an embodiment, block 282 may comprise maintaining the one or more data structures as a library of hierarchical data structures maintained in the memory that are selectable via user inputs received via a GUI (e.g., selection of data structure “Artificial Intelligence” hierarchical taxonomy 102, FIG. 1B). Classification attributes in such a maintained data structure may be specified and/or modified by selection of a corresponding node using the GUI as described above.

As pointed out above, terms to be incorporated in classification attributes to define a node of a hierarchical graph may be determined by a generative machine learning model such as a generative neural network model. According to an embodiment, such a generative machine learning model may be implemented as one or more generative neural network models configured as a natural language processing (NLP) model, such as LLMs powered by versions of models such as LongT5, MPT, Gemini, ChatGPT and Llama2, just to provide a few examples. FIG. 6A is a schematic diagram of one embodiment of a generative neural network model 600 such as an implementation of generative pretrained model, such as GPT, for example. FIG. 6B is a schematic diagram of another embodiment of generative neural network model 650 as an implementation of a generative pretrained model using a series of transformers 652. In one implementation, inputs generative neural network model 600 and/or 650 may comprise a series of words that are preprocessed (e.g., converted to numbers or other input vectors) and provided in sequence to generate output probabilities of a subsequent word. Such a series of words may be obtained and/or parsed from clinical records of patient encounters from a large corpus of clinical records in a pretraining operation. Once the subsequent word is determined, the subsequent word may be combined with the input so that the next subsequent word may be determined, causing transformers to repeatedly predict a next word in a response to a prompt. In one implementation, an input sequence may be fixed at some value, such as 2048 words, and extra positions at the beginning may be padded with zeros. An output may similarly comprise an array of possible outcomes with associated probabilities, such that the most probable subsequent word may be selected as the next word in the response or output.

Because input vectors in this particular example may indicate only a single word and comprise many more zeros than ones (e.g., GPT has a vocabulary of over 50,000 input words and associated vectors), the input vectors may be embedded or encoded into a smaller multidimensional space at an input embedding element. In generative neural network model 600 in particular, the position of each resulting token in a sequence of inputs may be encoded and provided to a multi-head attention element 606 operable to predict a degree to which an input token is likely to impact an output. Feed-forward blocks 612 may each comprise a multi-layer neural network, operable to learn over time to predict the next word in a sequence. An add & norm block 614 may combine and normalize outputs of multiple previous blocks.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames (such as implemented in a Web service). It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted that an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web service, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the terms “entry,” “electronic entry,” “document,” “electronic document,” “data object,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. In another embodiment, an electronic document, electronic content and/or digital content may comprise text, audio and/or image content formatted to be processed by a generative neural network model, or text, audio and/or image content generated by a generative neural network model. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, Apple Talk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, Apple Talk and/or the like. Versions of the Internet Protocol (IP) may include IPv4, IPv6, and/or other later to be developed versions.

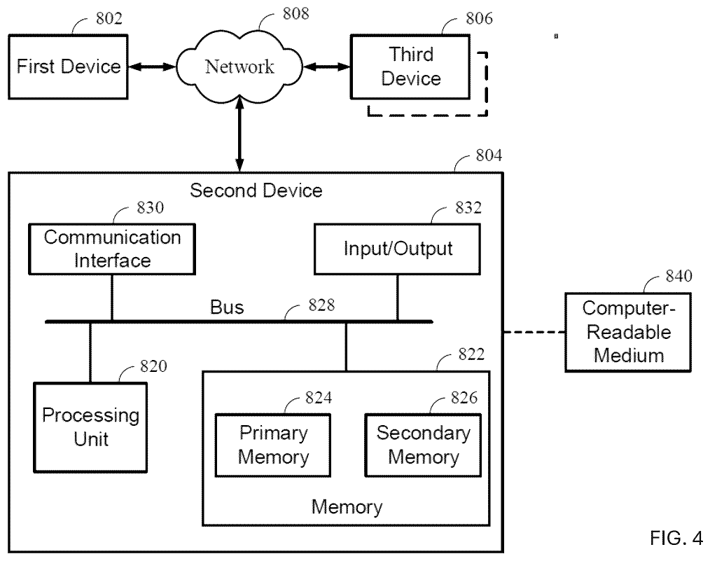

In one example embodiment, as shown in FIG. 4, a system embodiment may comprise a local network (e.g., device 804 and medium 840) and/or another type of network, such as a computing and/or communications network. For purposes of illustration, therefore, FIG. 4 shows an embodiment 800 of a system that may be employed to implement either type or both types of networks. Network 808 may comprise one or more network connections, links, processes, services, applications, and/or resources to facilitate and/or support communications, such as an exchange of communication signals, for example, between a computing device, such as 802, and another computing device, such as 806, which may, for example, comprise one or more client computing devices and/or one or more server computing device. By way of example, but not limitation, network 808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 4 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that fetches, interprets and executes instructions to process input signals to provide output signals. As such, in the context of the present patent application at least, computing device and/or processor are understood to refer to sufficient structure within the meaning of 35 USC § 112 (f) so that it is specifically intended that 35 USC § 112 (f) not be implicated by use of the term “computing device,” “processor” and/or similar terms; however, if it is determined, for some reason not immediately apparent, that the foregoing understanding cannot stand and that 35 USC § 112 (f), therefore, necessarily is implicated by the use of the term “computing device,” “processor” and/or similar terms, then, it is intended, pursuant to that statutory section, that corresponding structure, material and/or acts for performing one or more functions be understood and be interpreted to be described at least in FIGS. 1A though 1R, 2A, 2B, 3A and 3B, and in the text associated with the foregoing figure(s) of the present patent application.

Referring now to FIG. 4, in an embodiment, first and third devices 802 and 806 may be capable of rendering images for presentation on a display device a graphical user interface (GUI) (e.g., including a pointer device and/or other input device for providing user inputs to a GUI such as a microphone, touchscreen, track ball, etc.) for a network device and/or a computing device, for example, so that a user-operator may engage in system use. Such a GUI may be integrated with a display device (e.g., LED, LCD, CRT display device capable of presenting image responsive to an encoded video signal and/or encoded pixel values generated by a display controller, not shown) capable of presenting images based, at least in part, on states of application programs executing on a network device and/or a computing device. For example, such a GUI may receive user inputs from an input device that are referenced to a position on an image presented on a display device (e.g., position of a cursor) that affects execution of such an application program. Computing device 804 may potentially serve a similar function in this illustration. Likewise, in FIG. 4, computing device 802 (‘first device’ in figure) may interface with computing device 804 (‘second device’ in figure), which may, for example, also comprise features of a client computing device and/or a server computing device, in an embodiment. Processor (e.g., processing device) 820 and memory 822, which may comprise primary memory 824 and secondary memory 826, may communicate by way of a communication bus 815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 804, as depicted in FIG. 4, is merely one example, and claimed subject matter is not limited in scope to this particular example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a computing device and/or network device may include a numeric keypad and/or other display device of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that it may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. A computing and/or network device may also include executable computer instructions to process and/or communicate digital content. A computing and/or network device may also include executable computer instructions to perform a variety of possible tasks, such as browsing, searching, playing various forms of digital content, including locally stored and/or streamed video, and/or games such as, but not limited to, fantasy sports leagues. A computing and/or network device may also process input content as a prompt to one or more generative neural network models to provide output content. A computing and/or network device may also perform linguistic processing such as applying transforms to determine an embedding of tokens and/or apply attention models to determine service codes. The foregoing is provided merely to illustrate that claimed subject matter is intended to include a wide range of possible features and/or capabilities.

In FIG. 4, computing device 802 may provide one or more sources of executable computer instructions in the form physical states and/or signals (e.g., stored in memory states), for example. Computing device 802 may communicate with computing device 804 by way of a network connection, such as via network 808, for example. As previously mentioned, a connection, while physical, may not necessarily be tangible. Although computing device 804 of FIG. 4 shows various tangible, physical components, claimed subject matter is not limited to computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 822 may comprise any non-transitory storage mechanism. Memory 822 may comprise, for example, primary memory 824 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 822 may be utilized to store a program of executable computer instructions. For example, processor 820 may fetch executable instructions from memory and proceed to interpret and execute the fetched instructions. Memory 822 may also comprise a memory controller for accessing device readable-medium 840 that may carry and/or make accessible digital content, which may include code, and/or instructions, for example, executable by processor 820 and/or some other device, such as a controller, as one example, capable of executing computer instructions, for example. Under direction of processor 820, a non-transitory memory, such as memory cells storing physical states (e.g., memory states), comprising, for example, a program of executable computer instructions, may be executed by processor 820 and able to generate signals to be communicated via a network, for example, as previously described. Generated signals may also be stored in memory, also previously suggested. In a particular implementation, processor 820 may include general processing cores and/or specialized co-processing cores (e.g., signal processors, graphical processing unit (GPU) and/or neural network processing unit (NPU)), for example.

Memory 822 may store electronic files and/or electronic documents, such as relating to one or more users, and may also comprise a computer-readable medium that may carry and/or make accessible content, including code and/or instructions, for example, executable by processor 820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted that an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, service codes, tokens, computed likelihoods, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 4, processor 820 may comprise one or more circuits, such as digital circuits, to perform at least a portion of a computing procedure and/or process. By way of example, but not limitation, processor 820 may comprise one or more processors, such as controllers, microprocessors, microcontrollers, application specific integrated circuits, GPUs, NPUs, digital signal processors, programmable logic devices, field programmable gate arrays, the like, or any combination thereof. In various implementations and/or embodiments, processor 820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 4 also illustrates device 804 as including a component 832 operable with input/output devices, for example, so that signals and/or states may be appropriately communicated between devices, such as device 804 and an input device and/or device 804 and an output device. A user may make use of an input device, such as a computer mouse, stylus, track ball, microphone, scanner, touchscreen, keyboard, and/or any other similar device capable of receiving user actions and/or motions as input signals. Likewise, for a device having speech to text capability, a user may speak to a device to generate input signals. As pointed out above, such input devices may be integrated with a display device in a GUI in which processes user inputs referenced to a position of a cursor over aspects of images presented on the display device. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

Some embodiments may be described, at least in part, by the following numbered clauses or by any combination thereof:
Clause 1: An article comprising:
a non-transitory storage medium comprising computer-readable instructions stored thereon which are executable by one or more processors of a computing device to:
   initiate presentation of images on a display device integrated with the computing device, the images to include a hierarchical graph, the hierarchical graph to comprise nodes connected by edges descending from a root node, each node in the hierarchical graph to be electronically linked to a set of data objects in a memory, each child node in the hierarchical graph descending from a parent node in the hierarchical graph to be electronically linked to data objects in the memory which are a subset of the data objects in the memory linked to the parent node according to one or more classification attributes to be defined for the child node;
   obtain user inputs received via a graphical user interface (GUI) integrated with the display device to select a node in the hierarchical graph and apply the selected node to another node presented in the display device being electronically linked to one or more data objects maintained in the memory; and
   responsive to application of the selected node in the hierarchical graph to the another node, append one or more child nodes to the another node as a portion of a modified hierarchical graph presented in the display device, each appended child node to be electronically linked to data objects in the memory which are a subset of data objects in the memory electronically linked to the another node according to one or more classification attributes defining the selected node according to a predefined hierarchical taxonomy.
Clause 2: The article of clause 1, wherein the selected node comprises one or more child nodes in the hierarchical graph, and wherein each appended child node is electronically linked to data objects in the memory which are a subset of data objects in the memory electronically linked to the another node according to one or more classification attributes defining the one or more child nodes.
Clause 3: The article of clause 1, wherein the user inputs received via the GUI are to drag a selected child node from a first parent node in the hierarchical graph to disconnect the selected child node from the first parent node and ii) drop the disconnected selected child node to be connected to the another node; and
   responsive to the connection of the selected child node to the another node, link the selected child node to a subset of the data objects linked to the another node according to the one or more classification attributes defined for the selected child node.
Clause 4: The article of clause 3, wherein:
   the another node comprises a second parent node in the hierarchical graph;
   the first parent node is electronically linked to a first set of electronic documents stored in the memory;
   the selected child node, while connected to the first parent node, is to be electronically linked to a subset of the first set of electronic documents determined according to the classification attributes defined for the selected child node applied to the first set of electronic documents;
   the second parent node is to be electronically linked to a second set of electronic documents stored in the memory; and
   the selected child node, while connected to the second parent node, is to be electronically linked to a subset of the second set of electronic documents determined according to the classification attributes defined for the selected child node applied to the second set of electronic documents.
Clause 5: The article of clause 4, wherein:
   the hierarchical graph comprises a grandchild node descending from the selected child node by an edge;
   while the selected child node is connected to the first parent node, the grandchild node is to be linked to a subset of the first set of electronic documents determined according to the classification attributes defined for the selected child node and classification attributes defined for the grandchild node; and
   while the selected child node is connected to the second parent node, the grandchild node is to be linked to a subset of the second set of electronic documents determined according to the classification attributes defined for the selected child node and the classification attributes defined for the grandchild node.
Clause 6: The article of clause 1, wherein:
   the data objects comprise electronic documents; and
   electronic documents electronically linked to a node are to be accessible, at least in part, via the GUI by selection of the node.
Clause 7: The article of clause 1, wherein the instructions are further executable by the one or more processors to:
   obtain a hierarchical data structure expressing a hierarchical taxonomy, the hierarchical data structure to have a root classification attribute node and a plurality of child classification attribute nodes descending from the root classification attribute node;
   initiate presentation, on the display device, application of the root classification attribute node to the selected node; and
   responsive to application of the root classification attribute node to the selected node, initiate presentation, on the display device, generated nodes descending from the selected node corresponding to the root classification attribute node and one or more of the child classification attribute nodes.
Clause 8: The article of clause 7, wherein the hierarchical data structure is to be obtained from a library of hierarchical data structures maintained in the memory.
Clause 9: The article of clause 7, wherein the hierarchical data structure is created, at least in part, by:
   presentation of at least a portion of the hierarchical data structure as a hierarchical graph on a display device;
   selection, via the GUI, of at least one node in the hierarchical graph; and
   receipt of text via the GUI to at least in part specify classification attributes of the selected node.
Clause 10: The article of clause 9, wherein:
   the text is determined, at least in part, by terms generated by a generative neural network responsive to a prompt received via the GUI.
Clause 11: The article of clause 10, wherein the text is further based, at least in part, on edits of the terms generated by generative neural network via the GUI.
Clause 12: An article comprising:
   a non-transitory storage medium comprising computer-readable instructions stored thereon to:
   maintain one or more data structures in a memory, at least one of the data structures comprising a set of coupled classification attributes;
   initiate presentation of one or more images on a display device to indicate an application of the at least one of the data structures to a set of data objects electronically stored in the memory responsive to inputs received via a graphical user interface (GUI) integrated with the display device; and
   responsive to the application of the at least one the data structures to the set of electronically stored data objects, initiate presentation of a hierarchical graph on the display device, the hierarchical graph comprising:
   a root node to represent the set of data objects electronically stored in the memory; and
   a one or more child nodes connected to the root node by edges to represent data objects determined according to the application of the set of coupled classification attributes to the set of electronically stored data objects.
Clause 13: The article of clause 12, wherein presentation of one or more images on the display device to indicate the application of the at least one of the data structures to the set of data objects electronically stored in the memory responsive to inputs received via a graphical user interface (GUI) integrated with the display device comprises:
   presentation, on the display device, a discriminator hierarchical graph comprising a root discriminator node and child discriminator nodes connected to the root discriminator node, each of the child discriminator nodes to represent a hierarchically coupled classification discriminator of the set of hierarchically coupled classification discriminators;
   drag and drop of the root discriminator node on an image representing the set of data objects electronically stored in the memory; and
   responsive to drop of the root discriminator node on the image representing the set of data objects electronically stored in the memory, presentation of the hierarchical graph on the display device.
Clause 14: The article of clause 12, wherein the one or more data structures maintained in the memory are maintained as a library of hierarchical data structures maintained in the memory.
Clause 15: The article of clause 12, wherein the at least one of the data structures to comprise the set of hierarchically coupled classification discriminators is created, at least in part, by:
   presentation of at least a portion of the at least one of the data structures comprising the set of hierarchically coupled classification discriminators as a discriminator hierarchical graph;
   selection, via the GUI, of at least one node in the discriminator hierarchical graph; and
   receipt of text via the GUI to at least in part specify classification attributes of the selected node.
Clause 16: The article of clause 15, wherein:
   the text is determined, at least in part, by terms generated by a generative neural network responsive to a prompt received via the GUI.
Clause 17: The article of clause 16, wherein the text is further based, at least in part, on edits of the terms generated by generative neural network via the GUI.
Clause 18: An article comprising:
   a non-transitory storage medium comprising computer-readable instructions stored thereon to:
   initiation of presentation images on a display device including a first hierarchical graph, the first hierarchical graph comprising nodes connected by edges descending from a root node of the first hierarchical graph, each node in the first hierarchical graph to be electronically linked to a set of data objects in a memory, each child node in the first hierarchical graph descending from a parent node in the first hierarchical graph to be electronically linked to data objects in the memory which are a subset of the data objects in the memory linked to the parent node according to one or more classification attributes to be defined for the child node; and
   obtain user inputs received via a graphical user interface (GUI) integrated with the display device to select a node in the first hierarchical graph descending from the root node of the first hierarchical graph to initiate presentation of a second hierarchical graph in the display device, wherein:
   classification attributes define a root node of the second hierarchical graph comprising classification attributes that define the selected node in the first hierarchical graph.
Clause 19: The article of clause 18, wherein:
   the root node of the first hierarchical graph is to be electronically linked to a first set of data objects selected from a corpus of data objects according to classification attributes defining the root node of the first hierarchical graph; and
   the root node of the second hierarchical graph is to be electronically linked to a second set of data objects selected from the corpus of data objects according to classification attributes defining the selected node in the first hierarchical graph irrespective of classification attributes defining the root node of the first hierarchical graph.
Clause 20: The article of clause 19, wherein:
   the selected node in the first hierarchical graph is electronically linked to a first set of data objects which is different from a set of data objects linked to the root node of the second hierarchical graph.
Clause 21: The article of clause 19, wherein:
   the second hierarchical graph comprises one or more nodes descending from the root node in the second hierarchical graph corresponding to one or more nodes descending from the selected node in the first hierarchical graph; and
   classification attributes to define the one or more nodes descending from the root node in the second hierarchical graph to comprise classification attributes defining respective corresponding nodes descending from the selected node in the first hierarchical graph.
Clause 22: A computing device comprising:
   a display device; and
   one or more processors coupled to the display device to:
   initiate presentation of images on the display device integrated with the computing device, the images to include a hierarchical graph, the hierarchical graph to comprise nodes connected by edges descending from a root node, each node in the hierarchical graph to be electronically linked to a set of data objects in a memory, each child node in the hierarchical graph descending from a parent node in the hierarchical graph to be electronically linked to data objects in the memory which are a subset of the data objects in the memory linked to the parent node according to one or more classification attributes to be defined for the child node;
   obtain user inputs received via a graphical user interface (GUI) integrated with the display device to select a node in the hierarchical graph and apply the selected node to another node presented in the display device being electronically linked to one or more data objects maintained in the memory; and
   responsive to application of the selected node in the hierarchical graph to the another node, append one or more child nodes to the another node as a portion of a modified hierarchical graph presented in the display device, each appended child node to be electronically linked to data objects in the memory which are a subset of data objects in the memory electronically linked to the another node according to one or more classification attributes defining the selected node according to a predefined hierarchical taxonomy.
Clause 23: The computing device of clause 22, wherein the selected node comprises one or more child nodes in the hierarchical graph, and wherein each appended child node is electronically linked to data objects in the memory which are a subset of data objects in the memory electronically linked to the another node according to one or more classification attributes defining the one or more child nodes.
Clause 24: The computing device of clause 22, wherein the user inputs received via the GUI are to drag a selected child node from a first parent node in the hierarchical graph to disconnect the selected child node from the first parent node and ii) drop the disconnected selected child node to be connected to the another node; and
   responsive to the connection of the selected child node to the another node, link the selected child node to a subset of the data objects linked to the another node according to the one or more classification attributes defined for the selected child node.
Clause 25: The computing device of clause 24, wherein:
   the another node comprises a second parent node in the hierarchical graph;
   the first parent node is electronically linked to a first set of electronic documents stored in the memory;
   the selected child node, while connected to the first parent node, is to be electronically linked to a subset of the first set of electronic documents determined according to the classification attributes defined for the selected child node applied to the first set of electronic documents;
   the second parent node is to be electronically linked to a second set of electronic documents stored in the memory; and
   the selected child node, while connected to the second parent node, is to be electronically linked to a subset of the second set of electronic documents determined according to the classification attributes defined for the selected child node applied to the second set of electronic documents.
Clause 26: The computing device of clause 25, wherein:
   the hierarchical graph comprises a grandchild node descending from the selected child node by an edge;
   while the selected child node is connected to the first parent node, the grandchild node is to be linked to a subset of the first set of electronic documents determined according to the classification attributes defined for the selected child node and classification attributes defined for the grandchild node; and
   while the selected child node is connected to the second parent node, the grandchild node is to be linked to a subset of the second set of electronic documents determined according to the classification attributes defined for the selected child node and the classification attributes defined for the grandchild node.
Clause 27: The computing device of clause 22, wherein:
   the data objects comprise electronic documents; and
   electronic documents electronically linked to a node are to be accessible, at least in part, via the GUI by selection of the node.
Clause 28: The computing device of clause 22, wherein the instructions are further executable by the one or more processors to:
   obtain a hierarchical data structure expressing a hierarchical taxonomy, the hierarchical data structure to have a root classification attribute node and a plurality of child classification attribute nodes descending from the root classification attribute node;
   initiate presentation, on the display device, application of the root classification attribute node to the selected node; and
   responsive to application of the root classification attribute node to the selected node, initiate presentation, on the display device, generated nodes descending from the selected node corresponding to the root classification attribute node and one or more of the child classification attribute nodes.
Clause 29: The computing device of clause 28, wherein the hierarchical data structure is to be obtained from a library of hierarchical data structures maintained in the memory.
Clause 30: The computing device of clause 28, wherein the hierarchical data structure is created, at least in part, by:
   presentation of at least a portion of the hierarchical data structure as a hierarchical graph on a display device;
   selection, via the GUI, of at least one node in the hierarchical graph; and
   receipt of text via the GUI to at least in part specify classification attributes of the selected node.
Clause 31: The computing device of clause 30, wherein:
   the text is determined, at least in part, by terms generated by a generative neural network responsive to a prompt received via the GUI.
Clause 32: The computing device of clause 31, wherein the text is further based, at least in part, on edits of the terms generated by generative neural network via the GUI.
Clause 33: An computing device comprising:
   a display device; and
   one or more processors coupled to the display device to:
   maintain one or more data structures in a memory, at least one of the data structures comprising a set of coupled classification attributes;
   initiate presentation of one or more images on the display device to indicate an application of the at least one of the data structures to a set of data objects electronically stored in the memory responsive to inputs received via a graphical user interface (GUI) integrated with the display device; and
   responsive to the application of the at least one the data structures to the set of electronically stored data objects, initiate presentation of a hierarchical graph on the display device, the hierarchical graph comprising:
   a root node to represent the set of data objects electronically stored in the memory; and
   a one or more child nodes connected to the root node by edges to represent data objects determined according to the application of the set of coupled classification attributes to the set of electronically stored data objects.
Clause 34: The computing device of clause 33, wherein presentation of one or more images on the display device to indicate the application of the at least one of the data structures to the set of data objects electronically stored in the memory responsive to inputs received via a graphical user interface (GUI) integrated with the display device comprises:
   presentation, on the display device, a discriminator hierarchical graph comprising a root discriminator node and child discriminator nodes connected to the root discriminator node, each of the child discriminator nodes to represent a hierarchically coupled classification discriminator of the set of hierarchically coupled classification discriminators;
   drag and drop of the root discriminator node on an image representing the set of data objects electronically stored in the memory; and
   responsive to drop of the root discriminator node on the image representing the set of data objects electronically stored in the memory, presentation of the hierarchical graph on the display device.
Clause 35: The computing device of clause 33, wherein the one or more data structures maintained in the memory are maintained as a library of hierarchical data structures maintained in the memory.
Clause 36: The computing device of clause 33, wherein the at least one of the data structures to comprise the set of hierarchically coupled classification discriminators is created, at least in part, by:
   presentation of at least a portion of the at least one of the data structures comprising the set of hierarchically coupled classification discriminators as a discriminator hierarchical graph;
   selection, via the GUI, of at least one node in the discriminator hierarchical graph; and
   receipt of text via the GUI to at least in part specify classification attributes of the selected node.
Clause 37: The computing device of clause 36, wherein:
   the text is determined, at least in part, by terms generated by a generative neural network responsive to a prompt received via the GUI.
Clause 38: The computing device of clause 37, wherein the text is further based, at least in part, on edits of the terms generated by generative neural network via the GUI.
Clause 39: A computing device comprising:
   a display device; and
   one or more processors coupled to the display device to:
   initiate of presentation images on the display device including a first hierarchical graph, the first hierarchical graph comprising nodes connected by edges descending from a root node of the first hierarchical graph, each node in the first hierarchical graph to be electronically linked to a set of data objects in a memory, each child node in the first hierarchical graph descending from a parent node in the first hierarchical graph to be electronically linked to data objects in the memory which are a subset of the data objects in the memory linked to the parent node according to one or more classification attributes to be defined for the child node; and
   obtain user inputs received via a graphical user interface (GUI) integrated with the display device to select a node in the first hierarchical graph descending from the root node of the first hierarchical graph to initiate presentation of a second hierarchical graph in the display device, wherein:
   classification attributes define a root node of the second hierarchical graph comprising classification attributes that define the selected node in the first hierarchical graph.
Clause 40: The computing device of clause 39, wherein:
   the root node of the first hierarchical graph is to be electronically linked to a first set of data objects selected from a corpus of data objects according to classification attributes defining the root node of the first hierarchical graph; and
   the root node of the second hierarchical graph is to be electronically linked to a second set of data objects selected from the corpus of data objects according to classification attributes defining the selected node in the first hierarchical graph irrespective of classification attributes defining the root node of the first hierarchical graph.
Clause 41: The computing device of clause 40, wherein:
   the selected node in the first hierarchical graph is electronically linked to a first set of data objects which is different from a set of data objects linked to the root node of the second hierarchical graph.
Clause 42: The computing device of clause 40, wherein:
   the second hierarchical graph comprises one or more nodes descending from the root node in the second hierarchical graph corresponding to one or more nodes descending from the selected node in the first hierarchical graph; and
   classification attributes to define the one or more nodes descending from the root node in the second hierarchical graph to comprise classification attributes defining respective corresponding nodes descending from the selected node in the first hierarchical graph.

1. A method, at a computing device, comprising:
presenting images on a display device including a hierarchical graph, the hierarchical graph comprising nodes connected by edges descending from a root node, each node in the hierarchical graph to be electronically linked to a set of data objects in a memory, each child node in the hierarchical graph descending from a parent node in the hierarchical graph to be electronically linked to data objects in the memory which are a subset of the data objects in the memory linked to the parent node according to one or more classification attributes to be defined for the child node;
receiving user inputs via a graphical user interface (GUI) integrated with the display device to select a node in the hierarchical graph and apply the selected node to another node presented in the display device being electronically linked to one or more data objects maintained in the memory; and
responsive to application of the selected node in the hierarchical graph to the another node, appending one or more child nodes to the another node as a portion of a modified hierarchical graph presented in the display device, each appended child node being electronically linked to data objects in the memory which are a subset of data objects in the memory electronically linked to the another node according to one or more classification attributes defining the selected node according to a hierarchical taxonomy, wherein the one or more classification attributes defining the selected node are defined by machine learning, vector space analysis or Boolean expression.

2. The method of claim 1, wherein one or more child nodes in the hierarchical graph descend from the selected node, and wherein each appended child node is electronically linked to data objects in the memory which are a subset of data objects in the memory electronically linked to the another node according to one or more classification attributes defining the one or more child nodes.

3. The method of claim 1, wherein the user inputs received via the GUI are to drag a selected child node from a first parent node in the hierarchical graph to disconnect the selected child node from the first parent node and ii) drop the disconnected selected child node to be connected to the another node; and
responsive to connection of the selected child node to the another node, linking the selected child node to a subset of the data objects linked to the another node according to the one or more classification attributes defined for the selected child node.

4. The method of claim 3, wherein:
the another node comprises a second parent node in the hierarchical graph;
the first parent node is electronically linked to a first set of electronic documents stored in the memory;
the selected child node, prior to disconnection of the selected child node from the first parent node, is electronically linked to a subset of the first set of electronic documents determined according to the classification attributes defined for the selected child node applied to the first set of electronic documents;
the second parent node is electronically linked to a second set of electronic documents stored in the memory; and
the selected child node, subsequent to the connection of the selected child node to the second parent node, is electronically linked to a subset of the second set of electronic documents determined according to the classification attributes defined for the selected child node applied to the second set of electronic documents.

5. The method of claim 4, wherein:
the hierarchical graph comprises a grandchild node descending from the selected child node by an edge;
prior to disconnection of the selected child node from the first parent node, the grandchild node is linked to a subset of the first set of electronic documents determined according to the classification attributes defined for the selected child node and classification attributes defined for the grandchild node; and
subsequent to the connection of the selected child node to the second parent node, the grandchild node is linked to a subset of the second set of electronic documents determined according to the classification attributes defined for the selected child node and the classification attributes defined for the grandchild node.

6. The method of claim 1, wherein:
the data objects comprise electronic documents; and
electronic documents electronically linked to a node are accessible, at least in part, via the GUI by selection of the node.

7. The method of claim 1, and further comprising, responsive to the received user inputs:
obtaining a hierarchical data structure expressing a hierarchical taxonomy, the hierarchical data structure having a root classification attribute node and a plurality of child classification attribute nodes descending from the root classification attribute node;
presenting, on the display device, application of the root classification attribute node to the selected node; and
responsive to application of the root classification attribute node to the selected node, presenting, on the display device, generated nodes descending from the selected node corresponding to the root classification attribute node and one or more of the child classification attribute nodes.

8. The method of claim 7, wherein the hierarchical data structure is obtained from a library of hierarchical data structures maintained in the memory.

9. The method of claim 7, wherein the hierarchical data structure is created, at least in part, by:
presentation of at least a portion of the hierarchical data structure as a hierarchical graph on a display device;
selection, via the GUI, of at least one node in the hierarchical graph; and
receipt of text via the GUI to at least in part specify classification attributes of the selected node.

10. The method of claim 9, wherein:
the text is determined, at least in part, by terms generated by a generative neural network responsive to a prompt received via the GUI.

11. The method of claim 10, wherein the text is further based, at least in part, on edits of the terms generated by generative neural network via the GUI.

12. A method comprising:
maintaining one or more data structures in a memory, at least one of the data structures comprising a set of coupled classification attributes, wherein the set of classification attributes is defined by machine learning, vector space analysis or Boolean expression;
presenting one or more images on a display device to indicate an application of the at least one of the data structures to a set of data objects electronically stored in the memory responsive to inputs received via a graphical user interface (GUI) integrated with the display device; and
responsive to the application of the at least one of the data structures to the set of electronically stored data objects, presenting a hierarchical graph on the display device, the hierarchical graph comprising:
a root node to represent the set of data objects electronically stored in the memory; and
one or more child nodes connected to the root node by edges to represent data objects determined according to the application of the set of coupled classification attributes to the set of electronically stored data objects.

13. The method of claim 12, wherein presenting one or more images on the display device to indicate the application of the at least one of the data structures to the set of data objects electronically stored in the memory responsive to inputs received via a graphical user interface (GUI) integrated with the display device comprises:
presenting on the display device a discriminator hierarchical graph comprising a root discriminator node and child discriminator nodes connected to the root discriminator node, each of the child discriminator nodes to represent a hierarchically coupled classification discriminator of the set of hierarchically coupled classification discriminators;
dragging and dropping the root discriminator node on an image representing the set of data objects electronically stored in the memory; and
responsive to dropping the root discriminator node on the image representing the set of data objects electronically stored in the memory, presenting the hierarchical graph on the display device.

14. The method of claim 12, wherein the one or more data structures maintained in the memory are maintained as a library of hierarchical data structures maintained in the memory.

15. The method of claim 12, wherein the at least one of the data structures comprising the set of hierarchically coupled classification discriminators is created, at least in part, by:
presentation of at least a portion of the at least one of the data structures comprising the set of hierarchically coupled classification discriminators as a discriminator hierarchical graph;
selection, via the GUI, of at least one node in the discriminator hierarchical graph; and
receipt of text via the GUI to at least in part specify classification attributes of the selected at least one node.

16. The method of claim 15, wherein:
the text is determined, at least in part, by terms generated by a generative neural network responsive to a prompt received via the GUI.

17. The method of claim 16, wherein the text is further based, at least in part, on edits of the terms generated by generative neural network via the GUI.

18. A method comprising:
presenting images on a display device including a first hierarchical graph, the first hierarchical graph comprising nodes connected by edges descending from a root node of the first hierarchical graph, each node in the first hierarchical graph to be electronically linked to a set of data objects in a memory, each child node in the first hierarchical graph descending from a parent node in the first hierarchical graph to be electronically linked to data objects in the memory which are a subset of the data objects in the memory linked to the parent node according to one or more classification attributes to be defined for the child node; and
receiving user inputs via a graphical user interface (GUI) integrated with the display device to select a node in the first hierarchical graph descending from the root node of the first hierarchical graph to initiate presentation of a second hierarchical graph in the display device, wherein:
classification attributes define a root node of the second hierarchical graph comprising classification attributes that define the selected node in the first hierarchical graph, and wherein the classification attributes that define the selected node are defined by machine learning, vector space analysis or Boolean expression to select the subset of data objects.

19. The method of claim 18, wherein:
the root node of the first hierarchical graph is electronically linked to a first set of data objects selected from a corpus of data objects according to classification attributes defining the root node of the first hierarchical graph; and
the root node of the second hierarchical graph is electronically linked to a second set of data objects selected from the corpus of data objects according to classification attributes defining the selected node in the first hierarchical graph irrespective of classification attributes defining the root node of the first hierarchical graph.

20. The method of claim 19, wherein:
the selected node in the first hierarchical graph is electronically linked to a first set of data objects which is different from a set of data objects linked to the root node of the second hierarchical graph.

21. The method of claim 19, wherein:
the second hierarchical graph comprises one or more nodes descending from the root node in the second hierarchical graph corresponding to one or more nodes descending from the selected node in the first hierarchical graph; and
classification attributes defining the one or more nodes descending from the root node in the second hierarchical graph comprise classification attributes defining respective corresponding nodes descending from the selected node in the first hierarchical graph.
